(19) United States
(12) Patent Application Publication
(10) Pub. No.: US 2026/0102643 A1
(43) Pub. Date: Apr. 16, 2026

(54) Fire Protection Systems and Methods Using Fire Protection Devices Installed in Pipe Fittings With an Internally Housed Seal Member

(71) Applicant: Minimax Viking Patent Management GmbH, Bad Oldesloe (DE)

(72) Inventors: Shawn J. FEENSTRA, Caledonia, MI (US); Derek J. SCHEFFERS, Mattawan, MI (US); Martin H. WORKMAN, Delton, MI (US)

(21) Appl. No.: 19/274,587

(22) Filed: Jul. 20, 2025

Related U.S. Application Data
(63) Continuation-in-part of application No. 19/196,437, filed on May 1, 2025.
Application No. 19/196,437 is a continuation of application No. 19/055,095, filed on Feb. 17, 2025, now Pat. No. 12,330,001.
Application No. 19/055,095 is a continuation of application No. 18/514,577, filed on Nov. 20, 2023, now Pat. No. 12,257,465.
Application No. 18/514,577 is a continuation of application No. 17/915,291, now Pat. No. 11,872,425.
(63) Continuation of application No. 18/918,704, filed on Oct. 17, 2024.
Application No. 18/918,704 is a continuation of application No. 18/574,866, now Pat. No. 12,157,022.
(63) Continuation of application No. 17/944,264, filed on Sep. 14, 2022, now Pat. No. 12,544,609.
(63) Continuation of application No. 17/947,233, filed on Sep. 19, 2022.
(63) Continuation of application No. 17/947,407, filed on Sep. 19, 2022, now Pat. No. 12,458,821.
(63) Continuation of application No. 17/947,566, filed on Sep. 19, 2022, now Pat. No. 12,478,998.
(63) Continuation of application No. 17/948,503, filed on Sep. 20, 2022.
(63) Continuation of application No. 17/948,843, filed on Sep. 20, 2022.
(60) Provisional application No. 63/150,421, filed on Feb. 17, 2021.
(60) Provisional application No. 63/150,439, filed on Feb. 17, 2021.
(60) Provisional application No. 63/247,630, filed on Sep. 23, 2021.
(60) Provisional application No. 63/247,623, filed on Sep. 23, 2021.
(60) Provisional application No. 63/247,630, filed on Sep. 23, 2021.
(60) Provisional application No. 63/247,670, filed on Sep. 23, 2021.
(60) Provisional application No. 63/247,648, filed on Sep. 23, 2021.
(60) Provisional application No. 63/247,683, filed on Sep. 23, 2021.
(60) Provisional application No. 63/249,253, filed on Sep. 28, 2021.
(60) Provisional application No. 63/389,550, filed on Jul. 15, 2022.
(60) Provisional application No. 63/673,430, filed on Jul. 19, 2024.
(60) Provisional application No. 63/673,446, filed on Jul. 19, 2024.
(60) Provisional application No. 63/673,483, filed on Jul. 19, 2024.
(60) Provisional application No. 63/674,617, filed on Jul. 23, 2024.
(60) Provisional application No. 63/674,641, filed on Jul. 23, 2024.
(60) Provisional application No. 63/675,074, filed on Jul. 24, 2024.

(51) Int. Cl. A62C 31/28; A62C 37/12

(52) U.S. Cl. CPC A62C 31/28; A62C 37/12

(57) ABSTRACT

Fire protection systems and methods having piping interconnections for connecting a fire protection device to a fluid source. The piping interconnections include a branch connector connected to a pipe header. The branch connector includes a tubular member and an internal annular seal member housed in an internal gasket chamber of the tubular member. A tool includes a nozzle member and a plunger member is provided for inserting the annular seal member into the internal gasket chamber of the branch connector. The nozzle member has a guidance channel and a plunger member with a handle. With the nozzle member inserted into the branch connector, the handle of the plunger member is axially depressed to eject the annular seal member into the internal gasket chamber of the branch connector.

### PRIORITY DATA & INCORPORATION BY REFERENCE

This application is continuation-in-part of and claims priority to U.S. patent application Ser. No. 19/196,437, filed May 1, 2025, which is a continuation of U.S. patent application Ser. No. 19/055,095, filed Feb. 17, 2025, now U.S. Pat. No. 12,330,001, granted Jun. 17, 2025, which is a continuation of U.S. patent application Ser. No. 18/514,577, filed Nov. 20, 2023, now U.S. Pat. No. 12,257,465, granted Mar. 25, 2025, which is a continuation of U.S. patent application Ser. No. 17/915,291, filed Sep. 28, 2022, now U.S. Pat. No. 11,872,425, granted Jan. 16, 2024, which is a 35 U.S.C. § 371 application of International Application No. PCT/US2022/016868, filed Feb. 17, 2022, which claims the benefit of U.S. Provisional Application No. 63/150,421, filed Feb. 17, 2021, U.S. Provisional Application No. 63/150,439, filed Feb. 17, 2021, and U.S. Provisional Application No. 63/247,630, filed Sep. 23, 2021, each of which applications is incorporated by reference in its entirety.

This application also claims priority to U.S. Provisional Application No. 63/673,430 filed Jul. 19, 2024, U.S. Provisional Application No. 63/673,446 filed Jul. 19, 2024, U.S. Provisional Application No. 63/673,483 filed Jul. 19, 2024, U.S. Provisional Application No. 63/674,617 filed Jul. 23, 2024, U.S. Provisional Application No. 63/674,641 filed Jul. 23, 2024, and U.S. Provisional Application No. 63/675,074 filed Jul. 24, 2024, each of which is incorporated by reference in its entirety.

The application also is a continuation of and claims priority to U.S. application Ser. No. 18/918,704, filed Oct. 17, 2024, which is a continuation of U.S. application Ser. No. 18/547,866, filed on Jul. 11, 2023, now U.S. Pat. No. 12,157,022, which is a 35 U.S.C. §371 application of International Application No. PCT/2023/027337, which claims the benefit of U.S. Provisional Application 63/389,550, filed Jul. 15, 2022, U.S. application Ser. No. 17/944,264, filed Sep. 14, 2022, which claims the benefit of U.S. Provisional Application 63/247,623, filed Sep. 23, 2021, U.S. application Ser. No. 17/947,233, filed Sep. 19, 2022, which claims the benefit of U.S. Provisional Application 63/247,630, filed Sep. 23, 2021, U.S. application Ser. No. 17/947,407, filed Sep. 19, 2022, which claims the benefit of U.S. Provisional Application 63/247,670, filed Sep. 23, 2021, U.S. application Ser. No. 17/947,566, filed Sep. 19, 2022, which claims the benefit of U.S. Provisional Application 63/247,648, filed Sep. 23, 2021, U.S. application Ser. No. 17/948,503, filed Sep. 20, 2022, which claims the benefit of U.S. Provisional Application 63/247,683, filed on Sep. 23, 2021, and U.S. application Ser. No. 17/948,843, filed Sep. 20, 2022, which claims the benefit of U.S. Provisional Application 63/249,253, filed Sep. 28, 2021, and each of which is incorporated by reference in its entirety.

### TECHNICAL FIELD

The present invention relates generally to pipe fittings for fire protection systems. In particular, the present invention relates to a branch connector for connecting a fire protection device to a fluid supply pipe header in a network of pipes. Fire protection devices include fire protection sprinklers, mist devices, nozzles or any structure configured to distribute a firefighting fluid.

### BACKGROUND ART

Fire protection devices, such as automatic fire protection sprinklers, include a solid metal sprinkler body connected to a pressurized supply of water, and some type of deflector spaced from the outlet of the sprinkler body to distribute fluid discharged from the sprinkler body in a defined spray distribution pattern over an area to be protected. To control the firefighting fluid discharge from the sprinkler body, a fusible or thermally responsive trigger assembly which secures a seal over a central orifice of the sprinkler body, can be used. When the temperature surrounding the sprinkler is elevated to a pre-selected value indicative of a fire, the trigger assembly releases the seal and firefighting fluid (e.g., water) flow is initiated through the sprinkler body. The spray pattern or distribution of the firefighting fluid from the sprinkler defines sprinkler performance. Several factors can influence the fluid distribution patterns of a sprinkler including, for example, the shape of the sprinkler body and the geometry of the deflector. The deflector geometry can define the size, shape, uniformity, and fluid droplet size of the spray pattern.

The fluid discharge from the sprinkler body also impacts sprinkler performance. The discharge or flow characteristics of the sprinkler body is defined by the internal geometry of the sprinkler including its internal passageway, inlet and outlet (the sprinkler discharge orifice). Generally, the size of the sprinkler discharge orifice is defined by the nominal K-factor of the sprinkler. For a given sprinkler assembly, the larger the K-factor, the larger the discharge orifice, and the smaller the K-factor, the smaller the discharge orifice. Nominal K-factors for sprinklers listed in the National Fire Protection Association Standard Publication, NFPA 13: Standard for the Installation of Sprinkler Systems, can range from 1 to 30 [(gpm)/(psi.)^{1/2}] and greater. As is known in the art, the K-factor of a sprinkler is defined as K=Q/p^{1/2}, where Q represents the flow rate (in gallons/min (gpm)) of water from the outlet of the internal passage through the sprinkler body and P represents the pressure (in pounds per square inch (psi.)) of water or firefighting fluid fed into the inlet end of the internal passageway through the sprinkler body. Accordingly, the designed performance of a sprinkler is a function of the minimum pressure or flow of fluid supplying the sprinkler. Thus, any restriction to the fluid flow supply to a sprinkler can negatively impact the performance of the sprinkler.

Automatic fire protection sprinklers are used, for example, in the protection of storage commodities and occupancies. Storage fire protection systems include a network of pipes connected to a firefighting fluid supply source and installed above the storage commodity beneath the ceiling of the occupancy. The piping network includes one or more branch lines coupled to a cross-main which is connected to a fluid supply by a vertical piping riser to supply the branch line(s) with the firefighting fluid. Fire protection sprinklers are connected to the branch lines in an appropriate orientation and at an appropriate sprinkler-to-sprinkler spacing.

To connect the fire protection sprinklers to the branch lines, the branch lines are configured as linear pipe headers with branch connectors extending from the header for receipt and threaded connection of a fire protection sprinkler. Known connectors have one inlet end configured for welded connection to the pipe header and an opposite outlet end with a tapered threaded end for connection of a sprinkler. In order to form a fluid tight seal between the threadedly engaged connector and the sprinkler, a sealing tape or putty is applied to the sprinkler. This can be labor intensive and add to the installation time. Moreover, in order to form a fluid tight seal between the cooperating tapered threads, the sprinkler must be properly torqued using a wrench. Although a fluid tight seal is formed, the sprinkler may not be properly rotationally oriented for sprinkler operation.

There are known branch connectors which eliminate either or both of the tapered thread connection or the need to apply a sealing tape or putty. For example, each of U.S. Pat. Nos. 8,297,663 and 10,744,527, U.S. Patent Publication No. 2019/0175968 and Korean Patent Publication No. KR20040108608A show and describe connectors or adapters for connecting a fire protection sprinkler to a pipe header. Each of U.S. Pat. No. 10,744,527, and U.S. Patent Publication No. 2019/0175968 use an internal straight thread at the outlet to connect the tapered thread of the fire protection sprinkler, which allows the sprinkler to be placed in a desired rotational orientation without the interference of the thread engagement. To form a fluid tight seal between the connector and the sprinkler, each of U.S. Pat. Nos. 8,297,663 and 10,744,527, U.S. Patent Publication No. 2019/0175968 and Korean Patent Publication No. KR20040108608A employ an internal annular seal member which eliminates the need to apply a separate sealing tape or putty. In forming the fluid tight seal, the seal member is compressed against the internal surface of the connector. One area of concern in using an internal sealing member is the need to make sure that the compression of the seal does not restrict the fluid flow supply through the connector to the sprinkler which can negatively impact the discharge and distribution from the sprinkler. Some of the patent documents describe a geometric solution to minimize fluid flow interference. For example, U.S. Pat. No. 10,744,527 describes seal member geometries that, in combination with the internal geometry of the connector, prevent or eliminate restriction to the fluid flow through the connector that would negatively impact sprinkler performance. U.S. Patent Publication No. 2019/0175968 describes an alternate solution in which the connector includes an expansion volume above or axially adjacent the seal member into which the distorted seal member can expand.

The prior art presents connectors that include a seal and provide methods to eliminate or minimize a restrictive flow through the connector; however, the prior art raises additional concerns or problems in the connector structure. For example, U.S. Pat. No. 8,297,663 describes that the seal member is still permitted to distort radially inwardly in the direction of the fluid flow path. U.S. Patent Publication No. 2019/0175968, KR20040108608A and PCT Patent Publication No. WO 2021/186369 add complexity to the connector assembly because each of these patent documents show and describe connectors using a multi-component assembly in addition to the separate annular seal. For example, U.S. Patent Publication No. 2019/0175968 describes a branch connector with a multi-piece tube or housing that uses a threaded connection therebetween that relies on the same annular seal to form a fluid tight seal between the housing components. KR20040108608A shows and describes an internal locking ring in addition to an internal sealing member in order to retain the fire protection sprinkler in the branch connector.

Additionally, branch connectors shown in each of U.S. Pat. Nos. 8,297,663 and 10,744,527, U.S. Patent Publication No. 2019/0175968, Korean Patent Publication No. KR20040108608A and PCT Patent Publication No. WO 2021/186369 add complexity to the fire protection system installation. The connectors described in each of these patent documents receive a pipe fitting or conduit that is connected to the pipe header in order to receive the supplied firefighting fluid. The conduit is inserted into the inlet opening of the connector and firefighting fluid is then introduced internally downstream of the point of insertion. These known connectors have an internal surface that circumferentially surrounds the conduit and includes a stepped surface that provides an internal annular shelf to support the inserted end of the fluid carrying conduit. The annular shelf is defined by a transverse portion of the stepped surface that extends radially inward transverse to the internal passageway of the connector. The annular shelf is also defined by an axially extending portion of the stepped surface that runs parallel to the internal passageway of the connector. Collectively, the transverse and axially extending portions of the stepped surface form the annular shelf as a cantilevered structure off of the internal surface of the connector. These connectors can be affixed to the inserted supply conduit by an adhesive applied internally into the connector.

Other known branch connectors are shown and described in PCT Patent Publication No. WO 2021/198812 that are directly welded to the pipe header and therefore eliminate the need for an inlet surface configured for receipt of a supply conduit. However, the described connector adds complexity to the system assembly and installation because the connector is used with a fire protection sprinkler in which the seal member is attached to the sprinkler. Thus, branch connectors shown and described in PCT Patent Publication No. WO 2021/198812 require a particular seal and sprinkler configuration to form a proper seal. The particular arrangement shows the internal thread of the connector between the fluid inlet and the annular seal. With the seal shown housed near the open end of the connector, the seal can be exposed to the surrounding environment which can damage the seal.

Placement of the annular seal member is important to forming a proper seal regardless of where the seal is in a branch connector. U.S. Pat. No. 10,744,527 describes positioning and orienting an annular seal member internally within the connector to form a proper seal with an inserted fire protection sprinkler. There are known commercially available tools to insert the seal member into the connector. These installation tools employ a plunger and nozzle that engage the connector to insert the seal member. The plunger uses a handle arrangement similar to a caulking gun to drive the plunger to drive the seal member through the nozzle and into the proper place and orientation within the connector. One problem with this known installation tool is that the gun-like handle is bulky and can be difficult in tight spaces in which there may be obstructions.

Given the installation complexity and operational concerns with known branch connectors, there remains a need for a simplified internal sealing assembly and arrangement in branch connectors that can couple fire protection devices to system piping in a sustainable fluid-tight manner while providing adequate fluid flow to the devices for effective fire protection.

### Disclosure of the Invention

Preferred embodiments of fire protection systems and methods are provided in which the systems and methods use preferred piping interconnections between fire fluid devices and a source of firefighting fluid. The piping interconnections include a preferred branch connector for connecting a fire protection device to a pipe header in a network of pipes of the fire protection system. Preferred embodiments of the branch connector include a preferably unitary tubular member having a first end for direct connection to the supply pipe header, a second end for connection to the fluid distribution device, and an internal passageway extending along a central longitudinal axis from the first end to the second end. The internal passageway preferably includes an internally threaded portion proximate the second end for coupling to the fluid distribution device, a fluid intake portion proximate the first end for intake of firefighting fluid from the pipe header and a preferred internal gasket chamber formed between the threaded and fluid intake portions to house an annular seal member. The fluid intake portion preferably extends from the first end to the gasket chamber and is preferably configured for direct fluid contact. Without the need to support an inserted fluid supply conduit, the internal surface defining the fluid intake portion of the branch connector is stepless. That is, as used herein, “stepless” means that the internal surface does not include a surface that extends transversely and axially parallel to the internal passageway to provide an internal annular shelf for support of an inserted conduit. The internal surface in preferred embodiments of the branch connector described herein define the gasket chamber with a first restriction and an axially spaced second restriction of the passageway to support the annular seal member with a relief wall between the first and second restriction to define an expansion volume about the annular seal member.

A preferred embodiment of a fire protection system includes a network of pipes for interconnecting fire protection devices to a source of firefighting fluid. The system and its network of pipes include a pipe header having an internal fluid passageway extending along a longitudinal axis with an opening formed radially about the longitudinal axis. A preferred branch connector is connected to the pipe header. The branch connector includes a unitary tubular member having a first terminal end, and a second terminal end spaced from the first terminal end. The unitary tubular member includes a gasket chamber surface between the first terminal end and the second terminal end with a single annular seal member housed in the tubular member and supported therein by the gasket chamber surface. An internally threaded surface is formed between the gasket chamber surface and the second terminal end, and an internal stepless surface extends from the first terminal end to the gasket chamber surface. The first terminal end is preferably welded about the opening in the pipe header with the stepless surface in fluid communication with the internal fluid passageway of the pipe header. The system also includes a fire protection device coupled to the branch connector. The device includes a frame having a frame body with a frame inlet, a frame outlet and a frame internal passageway extending from the frame inlet to the frame outlet along a device axis. The device can include a fluid deflection member coupled to the device frame and the frame body is in a threaded engagement with the internally threaded surface of the tubular member to compress the annular seal member and establish the fire protection device in fluid communication with the fluid passageway of the pipe header.

Another preferred embodiment of the fire protection system includes a network of pipes for connecting fire protection devices to a source of firefighting fluid. The network of pipes has branch lines that include a pipe header having an internal fluid passageway extending along a longitudinal axis with an opening formed therein radially about the longitudinal axis. The branch lines also include a branch connector having an annular seal member and a unitary tubular member. The tubular member has a first terminal end welded to the pipe header, and a second terminal end spaced from the first terminal end. The unitary tubular member includes an internal surface extending from the first terminal end to the second terminal end and circumscribed about a central axis of the tubular member extending perpendicular to the longitudinal axis of the pipe header. The internal surface includes a gasket chamber surface with the annular seal member housed and supported in the tubular member by the gasket chamber surface, an internally threaded surface between the gasket chamber surface and the second terminal end for engaging a fire protection device, and a stepless surface in fluid communication with the internal fluid passageway of the pipe header. The stepless surface extends from the first terminal end to the gasket chamber surface. In some embodiments, the annular seal member is housed against the internally threaded surface of the branch connector or the internal threads of an adapter that is threaded into the branch connector. In some other embodiments, the fire protection system includes a flexible hose or sprig and drop system to dispose the fire protection sprinkler away from the branch connector. An inlet end of the flexible hose or spring and drop system is threaded into or coupled to the branch connector while the fire protection sprinkler is threaded into or coupled to an outlet end of the flexible hose or sprig and drop system.

In yet another preferred embodiment, an adapter assembly is positioned between the branch connector and the fire protection sprinkler. The adapter assembly includes a pipe being either a rigid tubular member and/or a flexible tubular member. The pipe has an inlet end, an outlet end, an internal surface between the inlet end and the outlet end, an external inlet thread extending from the inlet end towards the outlet end, and a thread stop located at a predetermined position on an external wall of the adapter assembly. The predetermined position can correspond to a point where an annular seal member in a branch connector is compressed to form a fluid-tight seal. The thread stop contacts a corresponding surface at the terminal end of the branch connector to control the depth the pipe is inserted into the branch connector, and an internal surface. As used herein, a “thread stop” refers to a surface feature on the pipe having a geometry different than the external inlet thread of the pipe. Preferably, the thread stop is a thread of a larger size and/or a different thread type when compared to the external inlet thread. In some embodiments, the thread stop has a maximum diameter between the outer diameter of the pipe and the major diameter of the external inlet thread. The thread stop is preferably disposed on a helix or alternatively, the thread stop can be a planar surface that extends perpendicular to or at an angle from the outer diameter of the pipe toward a central sprinkler axis. The adapter assembly can further include a fitting having an internal inlet surface coupled to the outlet end of the pipe, a fitting gasket chamber, an annular seal member disposed within the fitting gasket chamber, an internal outlet thread extending from an outlet fitting end to the fitting gasket chamber, and an internal surface positioned between the internal inlet thread and the gasket chamber. The fire protection device is placed into the fitting creating a fluid-tight seal between the fitting and the fire protection device.

Preferred methods of providing fire protection system include placing an annular seal member in an unloaded condition within an internal gasket chamber formed along an internal surface extending along and circumscribed about a central axis of a preferred unitary tubular member. The gasket chamber is preferably located between an internally threaded surface and an internal stepless surface of the internal surface. The internally threaded surface is between the gasket chamber and a terminal outlet end of the tubular member, and the internal stepless surface preferably extends from the gasket chamber to a terminal inlet end of the tubular member in a welded connection to a pipe header of a network of pipes. The preferred method includes placing the annular seal member in a loaded condition within the internal gasket chamber with a fire protection device frame in threaded engagement with the internally threaded surface and fluid communication with the pipe header. Alternate methods include compressing the annular seal member into the gasket chamber with the adapter assembly and compressing a second annular seal member into a second gasket chamber positioned in the adapter assembly with the fire protection device. Alternate methods include threading the annular seal member into the branch connector and compressing the annular seal against the internally threaded surface of the branch connector.

One preferred embodiment of a branch connector for fire protection systems and methods described herein include an annular seal member having a first end seal surface, a second end seal surface, an inner surface defining an inner gasket diameter and a peripheral surface defining an outer gasket diameter. In some alternate embodiments, the annular seal member includes a threaded outer surface for threading the annular seal member into a branch connector. The tubular member has an inlet for connection to the supply pipe header, an outlet for connection to a fire protection fluid distribution device, and an internal surface defining an internal passageway extending along a central longitudinal axis from the inlet to the outlet. The internal passageway defines a minimum diameter for firefighting fluid to flow therethrough. The internal passageway also includes a preferred gasket chamber formed between the inlet and the outlet with the annular seal member disposed in the gasket chamber. The gasket chamber is preferably defined by a first restriction proximate the inlet; a second restriction proximate the outlet with a relief wall between the first restriction and the second restriction. The first and second restriction engaging the peripheral surface of the annular seal member to support the annular member within the gasket chamber such that the relief wall circumscribes the peripheral surface to define an expansion volume therebetween with a fluid flow path extending from the inlet to the outlet and through the inner surface of the annular seal member. Accordingly, a preferred method of connecting a fire protection fluid distribution device to a fluid supply pipe header is also provided. The preferred method includes providing an inlet end of a tubular member welded to the fluid supply pipe header; and radially expanding the annular seal member with the fluid distribution device threaded into an outlet of the tubular member such that the annular seal member radially expands into an expansion volume defined between two restrictions supporting the seal member about a central longitudinal axis of the tubular member.

Preferred embodiments of a tool for installing an annular seal member in an internal gasket chamber of a branch connector for fire protection fluid distribution devices is also provided. A preferred tool includes a nozzle member having a first end face and a second end face axially spaced from the first end face with an internal passageway for holding an annular seal member therein. The internal passageway extends axially from the first end face to the second end face along a central longitudinal axis. The tool also includes a plunger member having a rod portion with a handle portion at one end of the rod portion and a free end opposite the handle portion. The rod portion is disposed in the internal passageway of the nozzle member for a sliding engagement. The sliding engagement defines a first position of the plunger member with the handle portion axially spaced from the second end face of the nozzle member with the free end of the rod portion proximate the annular seal member within the second internal passageway and a second position of the plunger member with the handle portion proximate the second end face of the nozzle member such that the free end of the rod portion ejects the annular seal member out of the internal passageway. Alternatively, instead of a nozzle member, the tool can include an insertion extrusion and/or cavity on the outer diameter of the rod portion. The insertion extrusion mates to a corresponding feature on the annular seal member so that the annular seal member can be inserted (e.g., threaded) into the gasket chamber. The handle portion is preferably centered and coaxially aligned in each of the first and second positions. The rod portion is affixed centrally to the handle portion so as to expose a base surface of the handle portion. More preferably, the handle portion has a periphery that uniformly circumscribes a central axis of the tool. The handle portion preferably has a diameter greater than the rod portion so that the exposed base surface of the handle portion contacts the nozzle portion in the second position of the plunger member.

### BRIEF DESCRIPTION OF DRAWINGS

The accompanying drawings, which are incorporated herein and constitute part of this specification, illustrate exemplary embodiments of the invention, and together, with the general description given above and the detailed description given below, serve to explain the features of the invention. It should be understood that the preferred embodiments are some examples of the invention as provided by the appended claims.

FIG. 1 is an illustrative schematic view of a preferred embodiment of a fire protection system.

FIG. 1A is an exploded cross-sectional view connecting a preferred illustrative fire protection device to a fluid supply pipe header and preferred branch connector in the system of FIG. 1.

FIG. 2 is a partial cross-sectional view illustrating connection of the fire protection device to the pipe header using the branch connector of FIG. 1A.

FIG. 2A is a partial illustrative detailed cross-sectional view showing an annular seal member loaded by the connected device in the branch connector of FIG. 2.

FIG. 2B is a perspective exploded view of the preferred embodiment of the device of FIG. 1A and a preferred protective installation device for use in the system of FIG. 1.

FIG. 2C is a partial illustrative cross-sectional exploded view of the protected device assembly of FIG. 2B, pipe header and the preferred branch connector of FIG. 2.

FIG. 2D is a partial illustrative cross-sectional view of the interconnected protected device assembly of FIG. 2B, pipe header and the preferred branch connector of FIG. 2.

FIG. 3A is a cross-sectional view of the branch connector of FIG. 1A with the annular seal member in an unloaded state.

FIG. 3B is a detailed cross-sectional view of the branch connector in FIG. 3A.

FIG. 4 is a cross-sectional view of a preferred annular seal member for use in the branch connector of FIG. 3A.

FIG. 5A is a partial illustrative cross-sectional view of an alternate annular seal member loaded by the fire protection device in an alternate branch connector.

FIG. 5B is a partial illustrative cross-sectional view of the alternate annular seal member of FIG. 5A loaded by the fire protection device in the alternate branch connector of FIG. 5A.

FIG. 5C is a partial illustrative cross-sectional view of the alternate branch connector of FIG. 5A.

FIG. 5D is a cross-sectional view of an alternate annular seal member of FIG. 5A.

FIG. 6A is a partial illustrative cross-sectional view of an alternate annular seal member loaded by the fire protection device in an alternate branch connector.

FIG. 6B is a partial illustrative cross-sectional view of the alternate annular seal member of FIG. 6A loaded by the fire protection device in the alternate branch connector of FIG. 6A.

FIG. 6C is a partial illustrative cross-sectional view of the alternate branch connector of FIG. 6A.

FIG. 6D is a cross-sectional view of the alternative annular seal member of FIG. 6A.

FIG. 7A is a partial illustrative cross-sectional view of an alternate annular seal member loaded by the fire protection device in an adapter that is threaded into an alternate branch connector

FIG. 7B is a partial illustrative cross-sectional view of the alternate annular seal member of FIG. 7A loaded by the fire protection device in the adapter of FIG. 7A while threaded into an alternate branch connector of FIG. 7A.

FIG. 7C is a partial illustrative cross-sectional view of the adapter and alternate branch connector of FIG. 7A.

FIG. 7D is a cross-sectional view of the alternate annular seal member of FIG. 7A.

FIG. 8A is a partial illustrative cross-sectional view of an alternate annular seal member loaded by the fire protection device in an alternate branch connector.

FIG. 8B is a partial illustrative cross-sectional view of the alternate annular seal member of FIG. 8A loaded by the fire protection device in the alternate branch connector of FIG. 8A.

FIG. 8C is a partial illustrative cross-sectional view of the alternate branch connector of FIG. 8A.

FIG. 8D is a cross-sectional view of the alternate annular seal member of FIG. 8A.

FIG. 9A shows an embodiment of a sprig and drop assembly in a fire protection system using the annular seal member of FIG. 4.

FIG. 9B is a partial illustrative cross-sectional view of an embodiment of a sprig and drop assembly of FIG. 9A.

FIG. 9C is a partial illustrative cross-sectional view of an embodiment of a sprig and drop assembly of FIG. 9A.

FIG. 9B′ is a partial illustrative cross-sectional view of an alternate embodiment of a sprig and drop assembly of FIG. 9A.

FIG. 9B″ is a partial illustrative cross-sectional view of an alternate embodiment of a sprig and drop assembly of FIG. 9A.

FIG. 10 shows an embodiment of a flexible hose assembly in a fire protection system using the annular seal member of FIG. 4.

FIG. 11A is an exploded perspective view of a preferred installation tool for use with the branch connector of FIG. 3A.

FIG. 11B is a cross-sectional view of the preferred installation tool and branch connector of FIG. 11A.

FIG. 11C is another cross-sectional view of the preferred installation tool and branch connector of FIG. 11A.

FIG. 12A is an exploded perspective view of a preferred installation tool for use with the branch connector of FIG. 5A.

FIG. 12B is a cross-sectional view of the preferred installation tool and branch connector of FIG. 12A.

FIG. 12C is another cross-sectional view of the preferred installation tool and branch connector of FIG. 12A.

### MODE(S) FOR CARRYING OUT THE INVENTION

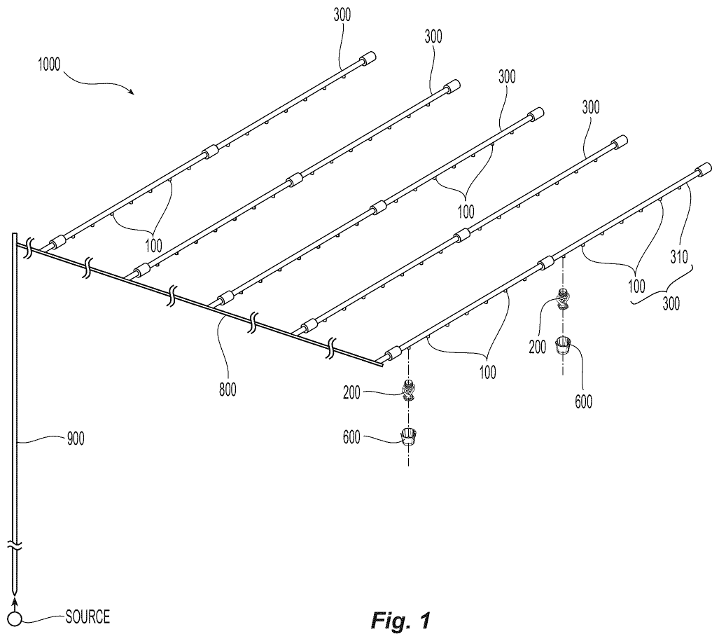

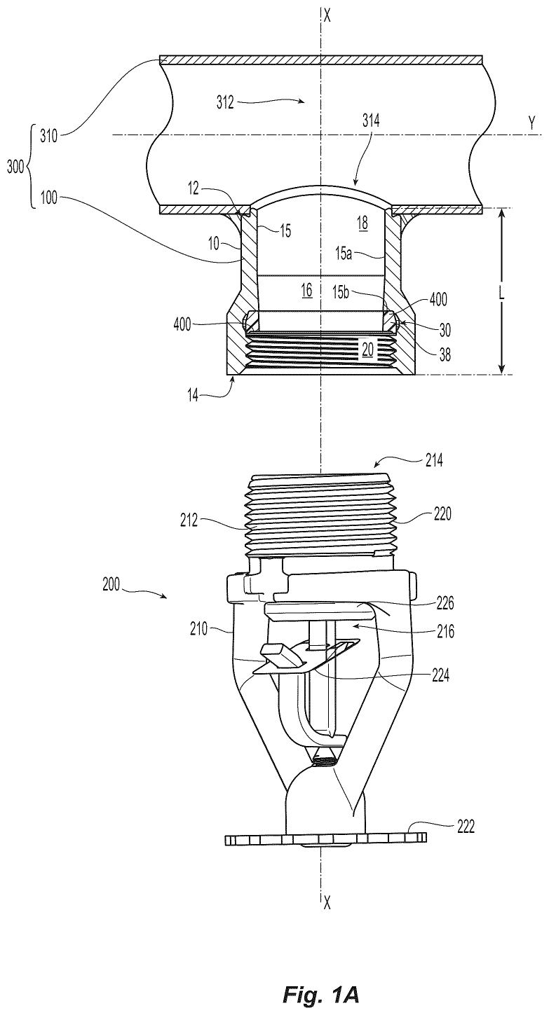

Shown in FIG. 1 is an illustrative schematic embodiment of a fire protection system that uses a preferred interconnection between a fire protection device 200 and a network of pipes 1000. Generally, the network of pipes 1000 couples the fire protection devices 200 to a supply of firefighting fluid (SOURCE), for example, a water main. Moreover, the network of pipes 1000 locate the fire protection devices 200 over an area or occupancy to be protected. For example, the system can be configured for protection of a storage occupancy by locating the devices in the ceiling above the storage and supplying the fire protection devices 200 with water. In the system shown, the network of pipes 1000 includes a vertical riser 900 coupled to the fluid supply source, a cross-member 800 coupled to the riser 900; and a plurality of spaced apart branch pipes 300 to which the fire protection devices 200 are connected. Each of the branch pipes 300 includes a pipe header 310 and a plurality of branch connectors 100 into which the fire protection devices 200 are threadedly connected. In each branch pipe 300, the branch connectors 100 are welded to the pipe header 310 and are preferably linearly spaced apart from one another. The preferred system includes a preferred interconnection between externally threaded fire protection devices 200 and internally threaded branch connectors 100 in which the fire protection devices 200 can be threaded into the fittings and more preferably hand threaded into the fittings to engage an internal seal to form a fluid-tight engagement and rotationally orient the device in a manner for effective fire protection. As described herein preferred embodiments of a protective device 600 can be used to install the fire protection devices 200 in the branch connectors 100.

Shown in FIG. 1A is a cross-sectional exploded view of a preferred embodiment of a preferred interconnection in which an externally threaded fire protection device 200, illustratively shown as a fire protection device 200, is threaded into a preferred branch connector 100 to couple and place the sprinkler into fluid communication with a pipe header 310. The branch connector 100 includes a generally tubular member 10 having a first inlet end 12 for fluid connection to the pipe header 310 and a second outlet end 14 for receipt of a fire protection device 200. The branch connector also includes a preferably single annular seal member 400 housed in a gasket chamber 30 positioned between the first and second ends 12, 14 for forming a fluid tight sealed engagement with the fire protection device 200 that is in a threaded engagement with an internal thread 20 of the tubular member 10. In preferred embodiments of the system, the pipe header 310 has internal fluid passageway 312 extending along a longitudinal axis Y--Y with an opening 314 formed therein radially about the longitudinal axis Y--Y. In the preferred branch connector 100 the tubular member is a preferably unitary tubular member 10 having a first terminal end 12, and a second terminal end 14 spaced from the first terminal end 12. The first terminal end is preferably welded about the opening 314 in the pipe header 310. The unitary tubular member 10 includes an internal surface 15 that is preferably circumscribed about a central tubular axis X--X and the internal surface 15 extends from the first terminal end 12 to the second terminal end 14 to define an internal passage 16 of the tubular member 10. The internal surface 15 preferably includes a gasket chamber surface 30 between the first terminal end 12 and the second terminal end 14 to define the preferred internal gasket chamber for housing and supporting the annular seal member 40 therein. An internally threaded surface 20 of the tubular member is preferably formed between the gasket chamber surface 30 and the second terminal end 14. In preferred embodiments of the tubular member 10, an internal stepless surface 15 extends from the first terminal end 12 to the gasket chamber surface 30 for fluid communication with the internal fluid passageway of the pipe header 310. In the system interconnections, a fire protection device 200 is in a threaded engagement with the internally threaded surface 20 of the tubular member 10 to compress the annular seal member and establish the fluid communication between the fire protection device 200 and the fluid passageway 312 of the pipe header 310. With the tubular member preferably welded to the pipe header 310, the stepless surface is in direct contact with the supplied firefighting fluid; and thus, a stepped internal surface for engaging an inserted supply conduit can be eliminated.

Generally, a fire protection device 200 includes a frame 210 having a frame body 212 with a frame inlet 214, a frame outlet 216 and an internal sprinkler passageway 218 extending from the frame inlet 214 to the frame outlet 216 along a central sprinkler axis to define a nominal K-factor of, for example, 8.0 [(gpm)/(psi.)^{1/2}] or greater. The body 212 preferably includes an external thread 220 for forming a preferred threaded engagement with the branch connector 100. The fire protection device 200, such as a sprinkler, can include a fluid deflection member 222 coupled to the sprinkler frame 210 for distributing firefighting fluid discharged from the frame outlet 216 to effectively address a fire. The fire protection device 200 preferably is configured as an automatic fire protection device in which a thermally responsive assembly 224, in combination with a seal assembly 226, maintains the fluid outlet 216 sealed in an unactuated state. In the presence of a sufficient level of heat, for example a fire, the thermally responsive assembly 224 actuates to release the seal assembly 226 and open the frame outlet 216 to permit the discharge of firefighting fluid. The fluid deflection member 222 can be at a fixed distance from the frame outlet 216 as shown or alternatively be movable, for example, to axially translate with respect to the frame outlet 216 from an unactuated position to an actuated position to distribute the discharged firefighting fluid. Depending upon the configuration of the fluid deflection member, the fire protection device 200 can be a pendent, an upright or a sidewall/horizontal device.

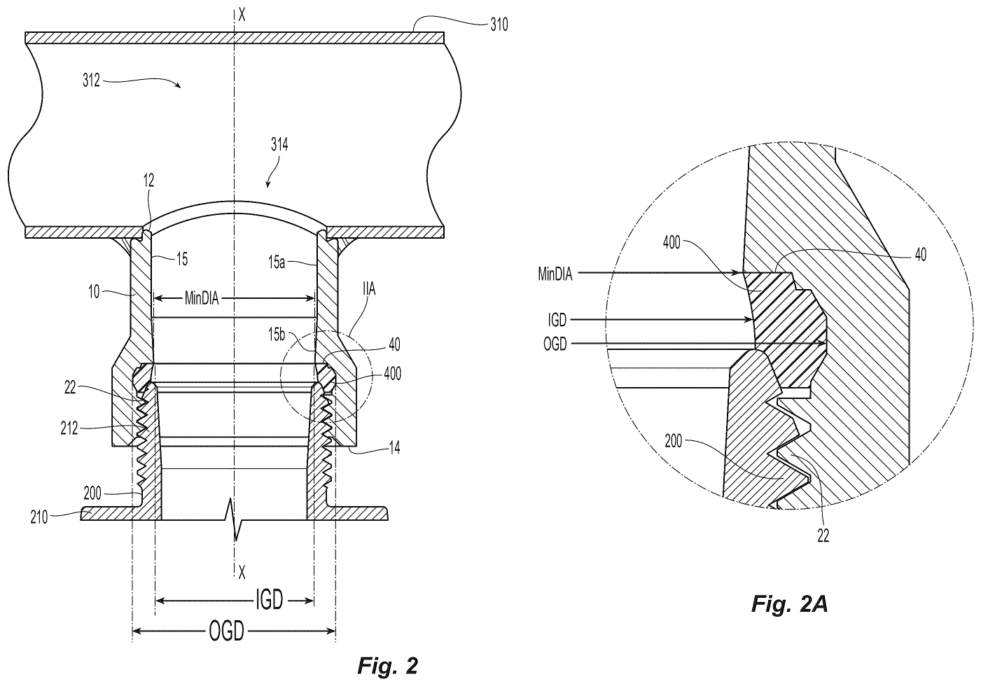

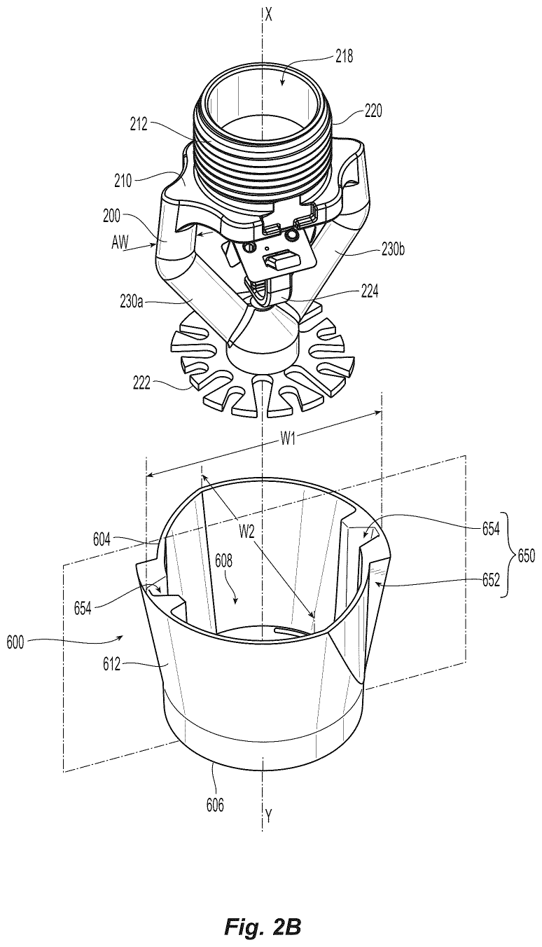

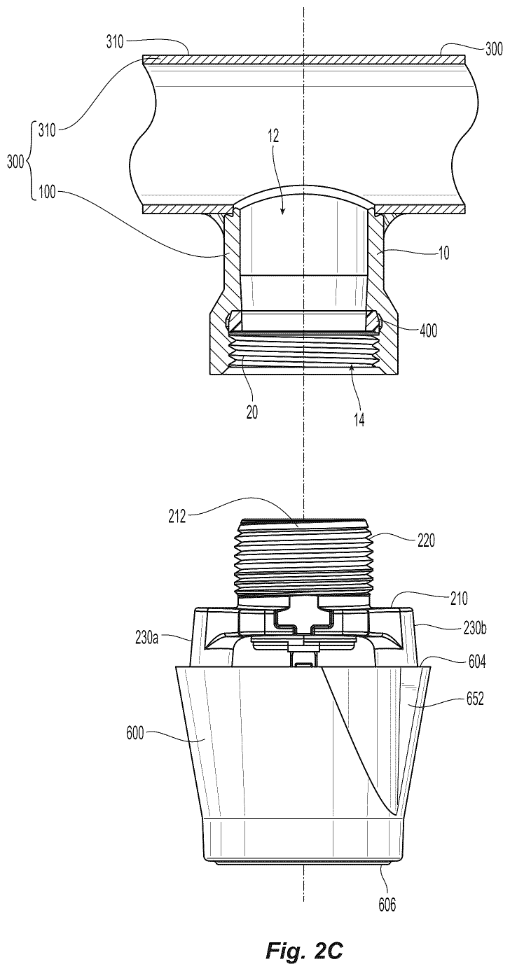

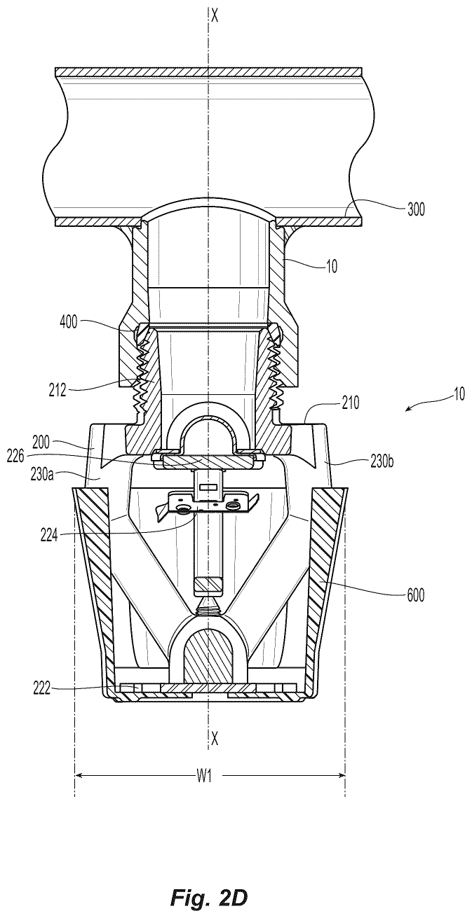

The branch connector 100 is preferably a straight fitting or alternatively can be formed as a different type of fitting, such as for example, an elbow fitting or tee fitting to connect an appropriately configured sprinkler. With reference again to FIGS. 1A and 2, preferred tubular member 10 of the branch connector 100 and its internal surface 15 defines the internal passageway 16 preferably extending along the central longitudinal axis X--X from the first end 12 to the second end 14. The internal passageway 16 preferably includes a fluid intake portion 18 proximate the inlet end 12 for intake of firefighting fluid from the pipe header 310. The preferably stepless surfaces 15a, 15b defines the fluid intake portion 18. The internal surface 15 includes the preferred internally threaded portion 20 proximate the outlet end 14 for receipt of and coupling to the fire protection device 200. The internal passageway 16 preferably includes the gasket chamber 30 formed between the fluid intake portion 18 and the internally threaded portion 20 to house an annular seal member 400. The surfaces defining the chamber 30 preferably include a backstop surface 40 against which the seal member 400 forms a fluid-tight sealed engagement when the seal member 400 is engaged and loaded by the fire protection device 200.

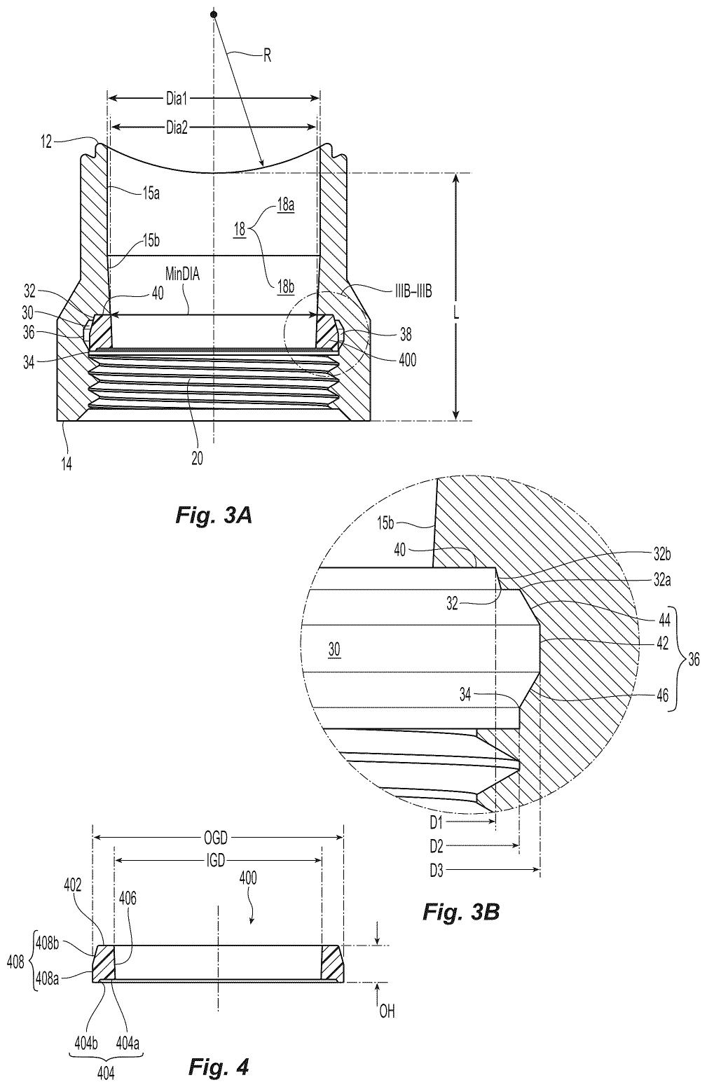

As previously described, the tubular member 10 is preferably formed as single-piece, monolithic or unitary structure. Moreover, the tubular member 10 is preferably formed or fabricated from a weldable material such as for example, steel or a weldable grade iron for welded connection to the pipe header 310. In preferred embodiments of the tubular member 10, the first terminal inlet end 12 defines a saddle-shaped surface, as more clearly seen in FIG. 3A, that is circumscribed about the central tubular axis X--X. The preferred saddle-shaped inlet end 12 defines a radius of curvature R about an axis extending perpendicular to and intersecting the central tubular axis X--X. The preferred saddle shaped inlet end 12 is configured to cradle the fluid supply pipe header 310 in a preferred welded connection. Moreover, as seen in FIG. 2, the inlet end surface 12 can be preferably tiered to define a portion that is disposed within the opening of the pipe header 310 and another portion outside the header opening that is incorporated in the preferred welded connection. With reference again to FIG. 3A, the inlet surface 15 is preferably contiguous with the inlet end 12 to define the preferred fluid intake portion 18 of the internal passageway 16 and its first internal diameter Dial for fluid communication with the pipe header 310. The inlet end 12 and the inlet diameter Dial defines a preferred ratio of radius of curvature R-to-diameter Dial that ranges from 1.3:1 to 1:1.

With reference to FIG. 3A, the fluid intake portion 18 of the tubular member preferably extends from the first inlet end 12 to the gasket chamber 30 and more preferably axially extends from the first terminal inlet end 12, then tapers and terminates at the sealing surface 40 of the gasket chamber 30. In the preferred embodiment, the fluid intake portion 18 includes a first portion 18a in which a first preferably stepless segment 15a of the internal surface 15 defines the preferably constant first internal diameter Dial of the passageway 16. A second portion 18b of the fluid intake portion 18 preferably defines a second internal diameter Dia2 that is variable and defined by a second preferably stepless segment 15b of the internal surface 15 that is preferably contiguous with the first segment. The second segment 15b of the stepless internal surface 15 defining the second portion 18b of the fluid intake portion 18 defines a profile from the first segment 15a to the backstop surface 40 to define the tapering second portion 18b of the fluid intake portion 18.

The second portion 18b of the fluid intake portion 18 preferably forms a tapering portion of the internal passageway 16 that tapers between the first portion 18a of the fluid intake portion 18 and the backstop surface 40 and preferably varies from a maximum equal to the first diameter Dial to a minimum equal to the minimum diameter MinDIA of the internal passageway 16. In the preferred tubular member 10, the first segment 15a of the internal surface 15 extends parallel to the central axis X--X to define a preferred constant diameter first part 18a of the fluid intake portion 18 over the first segment 15a. The first segment 15a is preferably between and contiguous with each of the first end 12 of the tubular member 10 and the second segment 15b of the internal surface. The second segment 15b is skewed with respect to the central axis X--X to define a preferred constant slope between and contiguous with each of the first segment 15a and the backstop surface 40 of the gasket chamber 30. Accordingly, the second segment 15b defines the preferred narrowly tapering diameter part 18b of the fluid intake portion 18 with the second segment 15b being between and contiguous with each of the first segment and the backstop surface 40 of the gasket chamber.

The second outlet end 14 of the tubular member 10 and the internally threaded portion 20 of the internal passageway 16 are preferably configured for receipt and connection with the fire protection device 200 of a nominal size. Accordingly, preferred embodiments of the branch connector 100 at the outlet end 14 can define a nominal size or diameter ranging from ½ inch to 1½ inch and more particularly any one of ½ inch, ¾ inch, and even more preferably any one of a nominal 1 inch, 1¼ inch or 1½ inch and suitable for receipt of a fire protection device having a nominal K-factor of 8.0 [(gpm)/(psi.)^{1/2}] or greater and more preferably, any one of 22.4; 25.2; 28.0; 30.5; 33.6 [(gpm)/(psi.)^{1/2}]. The overall length L of the branch connector between the inlet end 12 and the outlet end 14 preferably ranges from 1 inch to 1½ inch. The second terminal outlet end 14 is preferably defined by a circular planar surface circumscribed and disposed orthogonally with respect to the central axis X--X. The length L of the branch connector 100 is preferably defined between the outlet end 14 and a mid-point of the concave portion of the saddle-shaped inlet 12. Moreover, the overall length L of the branch connector 100 preferably corresponds or varies with the outlet nominal diameter size. For example, for a nominal outlet diameter of 1 inch, the length L is preferably 1¼ inch, where the nominal outlet diameter is ¾ inch, the length L is preferably 1⅛ inch and where the nominal outlet diameter is ½ inch, the length L is preferably 1 1/16 inch. Accordingly, the preferred tubular member 10 defines a preferred ratio of Length L-to-nominal outlet diameter that ranges from 1.25-2.1, can be any one of 1.25:1; 1.125:1 or 1.06:1 and is preferably 1.25-1.

With reference again to FIGS. 1A, 2 and 2A, the frame body 212 of the fire protection device 200 includes an external thread 220 for a threaded engagement with the internally threaded portion or surface 20 of the tubular member 10 with the frame body 212 in sealing engagement with the annular seal member 400. The annular seal member 400 is axially located between the fluid intake portion 18 and the threaded engagement, to place the internal passageway 218 of the fire protection device 200 in fluid communication with the internal passageway 16 of the tubular member 10. Generally, the external thread 220 of a fire protection device 200 is of a tapered form, for example, NPT thread. The internal threaded portion 20 preferably includes an internal straight thread 22 for receipt of the tapered sprinkler thread of the fire protection device 200. The threaded engagement remains sealed from fluid supplied through the inlet end 12 by the proper fluid tight seal sealed engagements between the annular seal member 400 and the backstop surface 40 and between the fire protection device 200 and the annular seal member 400. The internal diameter ID of the internal straight thread 22 can be defined by any one of the pitch diameter, minor diameter or major diameter of the internal thread 22 provided the straight thread engages the tapered thread of the fire protection device 200. The internal straight thread can be for example, a 1-11.5 NPSH Thread; a ¾-14 NPSH Thread; or a ½-14 NPS Thread for mating with a correspondingly nominal 1 inch, ¾ inch or ½ inch fire protection sprinkler.

Use of the preferred straight internal thread permits the tapered threaded fire protection device 200 to be rotatable about the axis X--X within the connector 10 such that the fire protection device 200 can be rotationally oriented, preferably by hand, in any desired position while forming a proper fluid tight seal. More preferably, the internal thread portion 20 and the seal member 400 form a proper fluid tight seal engagement with the fire protection device 200 upon sufficient rotation by hand of the device following contact with the seal member 400. Accordingly, in the preferred branch connector 100, the fire protection device 200 deforms the annular seal member 400 to provide a leak-proof fluid-tight seal between the device 200 and the connector 10 requiring a preferred lower torque as opposed to the higher torque that would be required in a typical fire protection sprinkler installation using a wrench and cooperating tapered threads. The preferred connector 10 can provide for a fluid tight seal between the connector 10 and a threaded fire protection device 200 under a fluid pressure of up to 200 psi or more, for example, pressures of up to and including at least 175 psi.

Alternatively or additionally, the preferred interconnection can include a preferred hand operated protective device 600 disposed about the fire protection device 200 for installing the fire protection device 200. Shown in FIGS. 2B, 2C and 2D are varying views, including exploded, partial cross-sectional and perspective views, of the fire protection device 200 and a protective device 600 for installation in the preferred branch connector 100. Preferred embodiments of the protective device 600 protect the fire protection device 200 from unintentional impact and damage during storage, transport, installation and/or when awaiting to be placed into service. Moreover, the protective device 600 also serves as a tool for installing the fire protection device 200 into the branch connector 100. A preferred protective device 600 facilitates installation of the fire protection device 200 by transferring an applied hand torque to install the fire protection device 200 into the branch connector 100 in a fluid tight manner as described herein.

The protective installation device 600 is preferably formed from a polymer or plastic material such as, for example, polyethylene and formed by molding such as, for example, injection molding. The protective device 600 is preferably formed as a tubular cap having a first end 604 defining an opening for axially receiving the fire protection device 200 and an opposite second end 606 coaxially centered and axially spaced from the first end 604. The tubular cap 602 defines an internal void 608 and volume for housing a portion of the received fire protection device 200. The tubular cap 602 includes a shielding wall 612 that preferably extends between the first end 604 and the second end 606 to define the internal void 608. Moreover, preferred embodiments of the protective device 600 (e.g., cap) and the shielding wall 612 define preferred torque assist features 650 of the protective device 600. Generally, the torque assist feature 650 includes one, and preferably more than one, external rotational drive formations for applying a torque to the fire protection device 200 and one, and preferably more than one, internal rotational drive formations for transferring the applied torque to the fire protection device 200 for rotation within the preferred threaded branch connector 100 to form a fluid tight connection therebetween. For example, the shielding wall 612 of the protective device 600 (e.g., protective cap) shown defines internal and external torque assist features 650 of the protective device 600. The external surface of the shielding wall 612 preferably includes a formation in the form of a planar external surface 652 that can serve as a lever surface against which an installer or user can press a thumb or finger(s) to apply a preferred hand torque. Internally, the protective device 600 includes at least one and preferably includes two diametrically opposed internal gripping formations or portions 654 to grip the sprinkler frame 210. Preferred embodiments of the sprinkler frame 210 include two frame arms 230a, 230b spaced apart the frame body 212. The protective device 600 preferably has a width W2 greater than a width of the frame arms 230a, 230b. Each gripping portion 654 defines an internal channel that extends axially preferably from the first end 604 to the second end 606 of the protective device 600. The channels of the gripping portion 654 also define a channel width in the angular direction about the device axis and a channel depth in a radial direction from the device axis. The frame arms 230a, 230b are axially received within the channels of the gripping portions 654. Preferred configurations of the gripping portions 654 facilitate the protective device 600 forming a preferred frictional surface engagement with the fire protection device 200 that prevents or minimizes relative rotation between the device 600 and the fire protection device 200 in order to apply the torque to the fire protection device 200 for installation into the preferred branch connector 100 in a fluid tight manner.

With reference to FIGS. 2C and 2D, the protective device 600 is located about the fire protection device 200 to axially extend from the frame body 212 to the fluid deflection member 222. Additionally, the protective device 600 is preferably disposed about the frame 210 to expose the wrench boss of the sprinkler frame for use of the protective device in combination with a wrench to install the fire protection device 200. Notwithstanding, preferred embodiments of the protected sprinkler assembly 200, 600 are configured for hand installation using the protective device 600 to form a fluid tight connection with the branch connector 100. The protective device 600 extends axially to the fluid deflection member 222 to house the fluid deflection member 222 and more preferably peripherally surround the fluid deflection member 222. Moreover, the preferred protective device 600 houses and protects the thermally responsive assembly 224. The device 600 preferably tapers or narrows in the axial direction from the first end 604 toward the second end 606. With reference to FIG. 2D, the internal surface of the device 600 can include one or more circumferentially extending ribs or projections to form a surface engagement and more preferably a snap-fit engagement with the fluid deflection member 222 of the inserted fire protection device 200 to secure the protective device 600 to the fire protection device 200. Additional features of a protective device 600 are shown and described in U.S. application Ser. No. 17/948,843, filed Sep. 20, 2022, which is incorporated by reference in its entirety. Alternatively, the protective cap can be the protective cap shown and described in U.S. application Ser. No. 18/918,704, filed on Oct. 17, 2024, U.S. application Ser. No. 17/947,407, filed on Sep. 19, 2022, U.S. application Ser. No. 17/944,264, filed on Sep. 14, 2022, U.S. application Ser. No. 17/947,566, filed on Sep. 19, 2022, U.S. application Ser. No. 17/948,503, filed on Sep. 20, 2022, and U.S. application Ser. No. 17/947,233, filed on Sep. 19, 2022, which are incorporated by reference in their entirety.

As described herein, the branch connector 100 includes a preferred internally formed gasket chamber 30 in which an annular seal member 400 is disposed. Firefighting fluid fed into the inlet end 12 flows through the annular seal out the outlet end 14 to supply the fire protection device 200 for discharge and distribution in accordance with the performance specification of the fire protection device 200. As shown in FIG. 3A, the gasket chamber 30 provides for a preferred expansion volume 38 or gap about the seal member 400 into which the seal can expand and/or deform radially outwardly. By providing the radial outward expansion volume 38, the inner area of the annular seal member 400 is maintained and/or maximized so as to minimize or prevent any restriction to the flow therethrough, thereby supplying a flow of fluid to the fire protection device 200 that maintains the discharge and distribution of fluid from the fire protection device 200.

Generally, the preferred internal gasket surfaces of the tubular member 10 that form the chamber 30 include two axially spaced apart radial restrictions 32, 34 to radially compress, support and locate the seal member 400 within the gasket chamber 30. The internal surface 15 defining the gasket chamber 30 includes a preferred relief wall 36 that preferably extends between the two restrictions 32, 34 that circumscribes the supported annular seal member 400 to define a preferred radial expansion volume 38 therebetween. As shown in FIG. 4, the annular seal member 400 includes a peripheral or outer wall surface profile that defines an outer gasket diameter OGD and an inner wall surface profile that defines an internal gasket diameter IGD. Either one or both of the outer and inner gasket diameters OGD, IGD can be constant or alternately vary over the axial length or height of the seal member 400. In preferred embodiments of the annular seal member 400, the inner gasket diameter IGD is 80% of the maximum outer gasket diameter OGD. FIG. 3A illustrates the preferred branch connector without a sprinkler threaded into the outlet end 14. Under such a condition, the annular seal member 400 is housed within the chamber 30 in an undeformed unloaded state.

Shown in FIGS. 2 and 2A is the cross-sectional view of the connector 10 with the fire protection device 200 threaded into the outlet end 14 and in sealed engagement with the seal member 400. In this loaded state, the annular seal member 400 compresses and deforms by expanding radially outward into the expansion volume 38 increasing the outer diameter of the gasket OGD. Moreover, by providing the radial outward expansion, the inner diameter IGD of the seal member 400 in the loaded state is preferably greater than or equal to a preferred minimum diameter MinDIA of the internal passageway 16 to maintain a preferred fluid flow through the annular member 400 and supplied to the fire protection device 200. The minimum diameter MinDIA of the internal passageway 16 is preferably larger than the nominal size of the sprinkler thread received at the internally threaded portion 20 preferably by a difference that ranges from 5-25%. Moreover, the difference between the minimum diameter MinDIA varies inversely with the nominal sprinkler size threaded into the outlet end 14. In a preferred example, for a nominal sprinkler size of ½ inch, the minimum diameter MinDIA of the internal passageway 16 is 20-25% greater; for a nominal sprinkler size of ¾ inch, the minimum diameter MinDIA is about 10% greater; and for a nominal sprinkler size one inch, the minimum diameter MinDIA of the internal passageway 16 is slightly less by about 10% and more preferably less within a range of 5% to 10%.

Preferably, a portion of the second segment 15b of the internal surface 15 proximate to or along the tapering part 18b of the fluid intake portion 18 defines the preferred minimum diameter MinDIA of the internal passageway 16. The backstop surface 40 of the gasket chamber 30, against which the annular seal member 40 seals, is preferably formed between the first restriction 32 and the fluid intake portion 18. Preferably, the backstop surface 40 is a planar annular surface formation that is disposed perpendicular to and circumscribed about the central longitudinal axis X--X and is contiguous with a terminal end of the second segment 15b of the internal surface 15 forming the tapering part 18b of the fluid intake portion 18. In preferred embodiments of the internal gasket chamber 30, the annular backstop surface 40 and its internal diameter defines the preferred minimum diameter MinDIA of the internal passageway 16.

Shown in FIGS. 3A and 3B are cross-sectional and detailed cross-sectional views of the branch connector 100 and the gasket chamber 30. The first restriction 32 of the internal gasket chamber 30 is preferably formed proximate the fluid intake portion 18 and the second restriction 34 is preferably formed proximate the internal threaded portion 20. More preferably, the first restriction 32 and the second restriction 34 are formed between the backstop 40 and the internal threaded portion 20. The relief wall 36 preferably approximates a concave surface that axially extends between the first restriction 32 and the second restriction 34 for defining the expansion volume 38 about the annular seal member 400. The preferred concave relief wall 36 is preferably defined by a plurality of adjacent surfaces of the internal surface 15 that circumscribe the central longitudinal axis X--X. The surfaces defining the relief wall 36 can also provide bearing surfaces against which the annular seal member 400 can rest in the loaded state of the seal member 400.

As seen in FIG. 3B, the plurality of adjacent surfaces preferably includes a central surface 42 that in cross-section extends axially parallel to the central longitudinal axis X--X and a pair of skewed surfaces 44, 46 disposed about and preferably contiguous with the central planar surface 42 that are circumscribed about and skewed with respect to the central longitudinal axis X--X. The concave relief wall 36 is preferably symmetrical about a plane disposed perpendicular to the central connector axis X--X and bisecting the central surface 42. In the preferred embodiment, the first skewed surface 44 is preferably proximate the backstop surface 40 with the second restriction 32 therebetween. The second skewed surface 46 is preferably adjacent and contiguous with the second restriction 34. Each of the restrictions 32, 34 are annular surfaces preferably circumscribed about the central longitudinal sprinkler axis X--X. Each of the annular restrictions 32, 34 or a portion thereof can extend axially parallel to the central longitudinal axis X--X. In the preferred embodiment, the restrictions 32, 34 are variably configured. For example, as seen in FIG. 3B, the first restriction 32 includes a first portion 32a disposed perpendicular to the central longitudinal axis X--X and a second portion 32b adjacent and contiguous with the backstop surface 40, with the second portion 32b being skewed with respect to the central longitudinal axis. In a dissimilar manner, the second restriction 34 is defined by a surface extending axially parallel to and circumscribed about the central longitudinal axis X--X.

Under load, the preferred geometry of gasket chamber 30 in combination with the preferred geometry of the seal member 400 provides for radial outward deformation of the seal member 400 minimizing or eliminating interference with the flow of water through the annular seal member 400. The annular seal member 400 is preferably configured as the seal shown and described in U.S. Pat. No. 10,744,527 to provide a preferred leak-proof connection between a fire protection sprinkler or other fire protection device 200 and the branch connector 100. The material employed for seal member 400 is an EPDM material having a durometer hardness of from 65 to 80, and preferably 70, to provide the desired sealing function and maintain sprinkler position. With reference to FIG. 4, the preferred annular seal member 400 preferably includes a first annular seat 402 for sealing against the backstop surface 40 of the connector 10 and a second annular seat 404 axially spaced from the first seat 402 for receipt of a fire protection device 200 in a sealed engagement. The first annular seat 402 and the second annular seat 404 are axially spaced apart from one another to define an overall height OH of the annular seal member 400. The first annular seat 402 is preferably planar and disposed perpendicular to the longitudinal axis. The second annular seat 404 preferably includes a first planar portion 404a that is parallel to the first seat 402 and a second portion 404b that is skewed with respect to the first portion 404a to define an annular lip that is configured to surround the thread of the received fire protection device 200. The first planar portion 404a engages the annular tip of the frame body 212 of a threaded fire protection device 200 to seal the connection between frame body 212 and the tubular member 10. The preferably skewed second portion 404b is tapered outwardly to allow easy insertion of the tip of the frame body 212 into the annular seal member 400 without damage. The first planar portion 404a is preferably spaced from the first annular seat 402 at a distance of 90%-95% of the overall height OH of the seal member 400 and more preferably spaced from the first annular seat 402 at a distance of 91%-92% of the overall height OH. Extending between the first and second seats 402, 404 is a preferred inner surface or wall 406 and a preferred peripheral surface or wall 408. The inner wall 406 is preferably skewed with respect to the first planar annular seat 402 to define a tapering flow through region of the seal member 400 that narrows in the direction from the first seat 402 toward the second seat 404. In a preferred embodiment, the inner wall 406 defines a preferred skew angle with the first seat 402 that ranges from 85-90 degrees; and more preferably is preferably 88 degrees. The outer peripheral wall 408 includes a first cylindrical portion 408a and a second conical frustum shaped portion 408b. Accordingly, the first cylindrical portion 408a defines a preferred constant outer diameter OGD and the conical portion 408b defines a variable outer diameter OGD that preferably decreases from a maximum at the diameter of the cylindrical portion to a minimum at the first seat 402. When the seal member 400 is installed in the branch connector 100, the first restriction 32 preferably engages the second portion 408b of the seal member and the second restriction 34 preferably engages the first portion 408a of the seal member to support the seal member 400 within the gasket chamber 30. In a preferred embodiment where the second portion 408b of the peripheral wall defines a preferred minimum outer diameter OGD of the seal member 400, the minimum outer diameter OGD is preferably 95%-96% of the constant outer diameter OGD defined by the first portion 408a of the peripheral wall 408. In a preferred embodiment of the branch connector 100, the internally threaded portion 20 defines a nominal one inch internal straight thread, the overall seal member height is about 0.2 inches, the constant outer diameter of the seal member is about 1.3 inches and the inner gasket diameter is about 1.1 inches.

Dimensionally, each of the first restriction 32 and second restriction 34 defines an internal diameter of the passageway 16 that is respectively preferably slightly less than the outer diameter OGD of the engaged portion 408a, 408b of the seal member 400 to radially compress the seal member 400. Preferably, the outer diameter of the seal member 400 and the smaller of the internal diameters of the restrictions 32, 34 define a differential therebetween that ranges from 0.01-0.1 inch. Moreover, in the preferred embodiment of the connector 10, the first restriction 32 defines an internal diameter D1 that is less than the internal diameter of the second restriction 34. The preferred central surface 42 of the relief wall 36 defines an internal diameter D3 that is greater than the maximum outer diameter of the unloaded annular seal member 400 to define the radial thickness of the expansion void 38 therebetween. In a preferred embodiment of the branch connector 100, the relief wall 36 defines an internal diameter D3 that is about 3% greater than the maximum gasket outer diameter OGD of the unloaded annular seal member 400. Preferably, the outer diameter of the unloaded annular seal member 400 and the larger inner diameter D3 of the central surface 42 define a preferred differential therebetween of about 0.05.

The gasket chamber 30 of the branch connector 100 defines a surface geometry and internal volume that supports and houses the annular seal member 400 in the unloaded state and provides the expansion volume 38 in which the seal member 400 is displaced in the loaded state of the annular seal member 400.

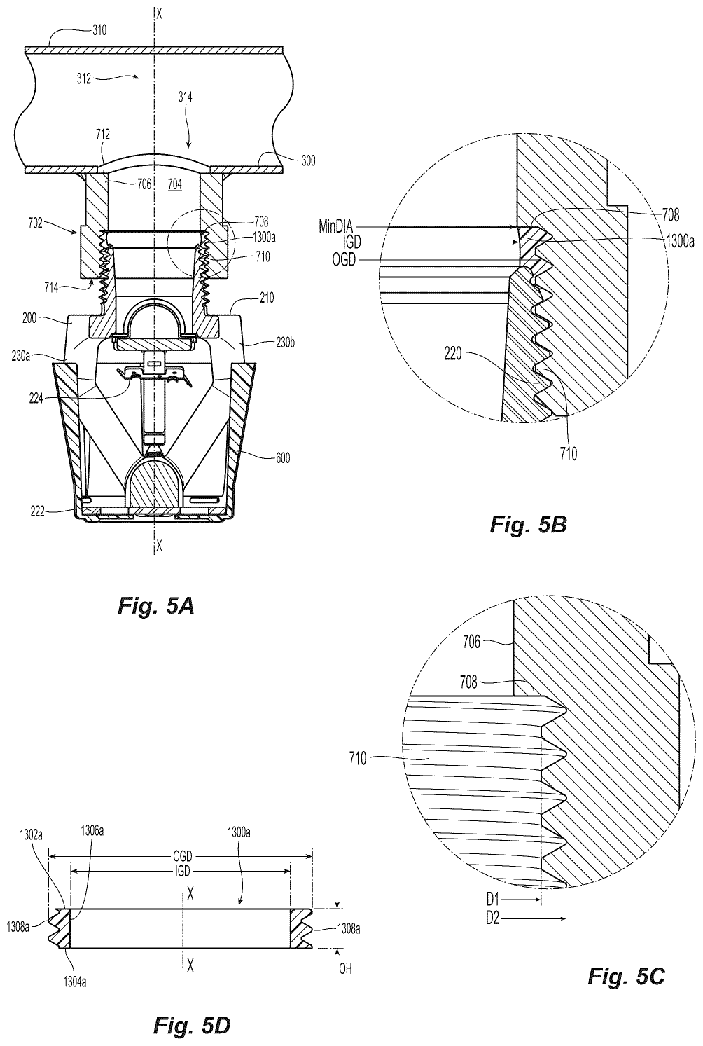

FIGS. 5A and 5B show an alternate annular seal member 1300a loaded by a fire protection device 200 while in a branch connector 702. FIG. 5C shows the branch connector 702 without the annular seal member 1300a. The branch connector 702 preferably connects to an appropriately configured fire protection device 200 using a protective device 600 that is located about the fire protection device 200. The branch connector 702 has an internal passageway 704 that extends along the central longitudinal axis X--X from the inlet end 712 to the outlet end 714. The internal passageway 704 includes the preferred internally threaded surface 710, proximate to the outlet end 714 for receiving and coupling to the fire protection device 200. The thread of the internally threaded surface 710 includes a minor diameter D1. The minor diameter of a thread is the smallest diameter of the thread. In some embodiments, D1 is larger than the diameter of the internal passageway 704. The thread includes a major diameter D2. The major diameter of a thread is the largest diameter of the thread. The difference between D1 and D2 is based on the thread size of the internally threaded surface 710.

The internal passageway 704 preferably includes the internal surface 706 formed between the inlet end 712 and a backstop 708. The backstop 708 is formed between the internal passageway 704 and the internally threaded surface 710. The surface of the backstop 708 is a planar annular surface formation that is disposed perpendicular to and circumscribed about the central longitudinal axis X--X and is contiguous with a terminal end of the internal surface 706. The annular seal member 1300a is axially located against the backstop 708 and supported by the internally threaded surface 710. The annular seal member 1300a is threaded into the internally threaded surface 710 to form a threaded engagement that remains sealed from fluid supplied through the inlet end 712.

The fluid-tight sealed engagements between the internally threaded surface 710, the annular seal member 1300a, and the fire protection device 200 are formed upon sufficient rotation of the fire protection device 200 following contact with the annular seal member 1300a. Accordingly, the fire protection device 200 deforms the annular seal member 1300a to provide the leak-proof fluid-tight seal between the fire protection device 200 and the branch connector 702. In the loaded state, the threads of the annular seal member 1300a compress and deform by expanding radially outward against the internally threaded surface 710, which increases the outer diameter OGD of the annular seal member 1300a. Moreover, by providing the radial outward expansion, the inner diameter IGD of the annular seal member 1300a in the loaded state is preferably greater than or equal to a preferred minimum diameter MinDIA of the internal passageway 704 to maintain a preferred fluid flow through the annular seal member 1300a and to the fire protection device 200.

FIG. 5D shows an alternate annular seal member 1300a. The annular seal member 1300a includes external threads 1308a, which are continuous threads circumscribed around the entire outer diameter wall of the annular seal member 1300a.

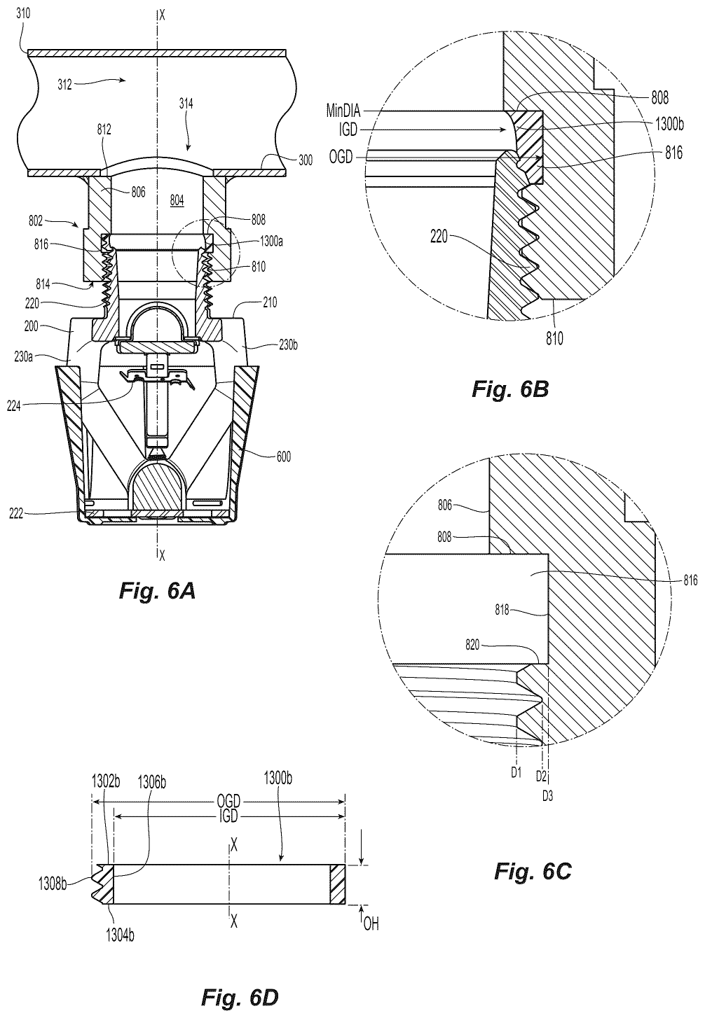

FIGS. 6A and 6B show an alternate annular seal member 1300b loaded by the fire protection device 200 in an alternate branch connector 802. FIG. 6C shows the branch connector 802 without the annular seal member 1300b. The branch connector 802 preferably connects to an appropriately configured fire protection device 200 using a protective device 600 that is located about the fire protection device 200. The branch connector 802 and the internal passageway 804, preferably, extend along the central longitudinal axis X--X from the inlet end 812 to the outlet end 814. The internal passageway 804 includes the preferred internally threaded surface 810, proximate to the outlet end 814 for receipt of and coupling to the fire protection device 200.

The internal passageway 804 preferably includes the gasket chamber 816 formed between the fluid intake portion 18 and the internally threaded surface 810 to house an annular seal member 1300b. The surfaces defining the gasket chamber 816 preferably include a backstop 808 which the annular seal member 1300b forms a fluid-tight sealed engagement with when the annular seal member 1300b is engaged and loaded by the fire protection device 200. The gasket chamber 816 further includes a wall 820 that defines a second internal support surface of the gasket chamber 816, when combined with the backstop 808 supports the annular seal member 1300b when the annular seal member 1300b is positioned in the gasket chamber 816. A relief wall 818 positioned between the backstop 808 and the wall 820 to define an outer diameter D2 that is greater than the major diameter D1 of the internally threaded surface 810. The frame body 212 of the fire protection device 200 includes an external thread 220 for a threaded engagement with the internally threaded surface 810 so that the frame body 212 can form a sealing engagement with the annular seal member 1300b. The annular seal member 1300b is threaded into the internally threaded surface 810 to place the annular seal member 1300b into the internal gasket chamber 816.

The fluid-tight threaded engagement between the internally threaded surface 810, the fire protection device 200, and the annular seal member 1300b is formed upon sufficient rotation of the fire protection device 200 following contact with the annular seal member 1300b. The gasket chamber 816 provides an area or gap for the annular seal member 1300b to expand and/or deform radially outwardly. In the loaded state, the threads of the annular seal member 1300b compress and deform by expanding radially outward into the expansion volume, compressing the external threads 1308a against the wall 818 of the gasket chamber 816. Moreover, by providing the radial outward expansion, the inner diameter IGD of the annular seal member 1300b in the loaded state is preferably greater than or equal to a preferred minimum diameter MinDIA of the internal passageway 804 to maintain a preferred fluid flow through the annular seal member 1300b that is supplied to the fire protection device 200.

FIG. 6D shows an alternate annular seal member 1300b. The annular seal member 1300b includes external threads 1308b, which are multiple sections of non-continuous threads or sealing thread segments that are circumscribed around the outer diameter wall of the annular seal member 1300b. For example, the non-continuous external threads 1308b can be positioned around the outer diameter wall at regular intervals. In one embodiment, the center of each section of external threads 1308b is positioned at 120-degree intervals around the inner wall 1306b of the annular seal member 1300b, so there are three different sections of external threads 1308b. In another embodiment, the center of each section of external threads 1308b is positioned at 90-degree intervals around the inner wall 1306b of the annular seal member 1300b, so there are four different sections of external threads 1308b.

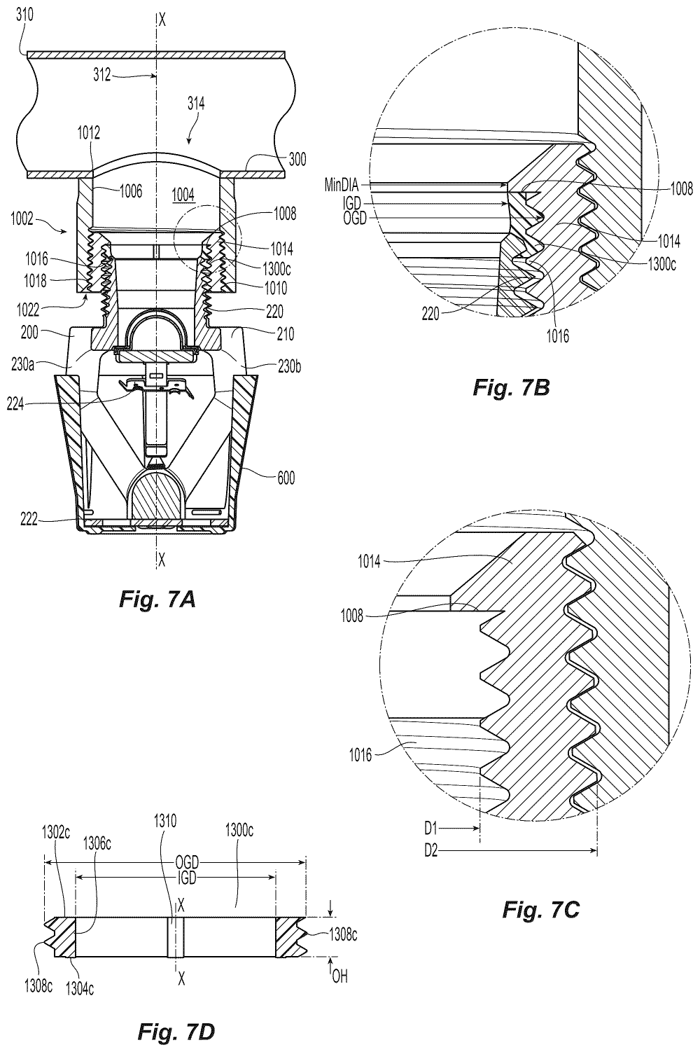

FIGS. 7A and 7B show an alternate annular seal member 1300c loaded by the fire protection device 200 in an adapter 1014 that is threaded into an alternate branch connector 1002. FIG. 7C shows the adapter 1014 without the annular seal member 1300c. The adapter 1014 preferably connects to an appropriately configured fire protection device 200 using a protective device 600 located about the fire protection device 200. The branch connector includes an internal passageway that includes an internally threaded surface 1010 positioned between the inlet end 1012 and outlet end 1022. The internal passageway 1004 includes an internal surface 1006 extending from the inlet end 1012 to the internally threaded surface 1010. The adapter 1014 is in a threaded engagement with the internally threaded surface 1010 of the branch connector 1002 to establish the fluid communication between the fire protection device 200 and the internal fluid passageway 312 of the pipe header 310. The adapter 1014 has a diameter D1 that is the minor diameter of the internal threads 1016 of the adapter 1014. The minor diameter of a thread is the smallest diameter of the thread. The adapter 1014 also includes a diameter D2 that is the major diameter of the external threads 1018 of the adapter 1014. The major diameter of a thread is the largest diameter of the thread. The difference between D1 and D2 varies depending on the thread size of the fire protection device 200.

The annular seal member 1300c is axially located between an outlet end 1022 and a backstop 1008 (e.g., planar backstop) of the adapter 1014. The annular seal member 1300c is threaded into the internal thread 1016 of the adapter 1014 to place the annular seal member 1300c against the backstop 1008 (e.g., planar backstop) to form a fluid-tight seal. The external threads 220 of the fire protection device 200 compress the external threads of the gasket against the internal threads 1016 of the adapter 1014 upon sufficient rotation of the fire protection device 200 following contact with the annular seal member 1300c to enable a fluid-tight seal. In the loaded state, the annular seal member 1300c compresses and deforms by expanding radially outward against the threads of the internal threads of the adapter 1014, increasing the gasket OGD's outer diameter. Moreover, the inner diameter IGD of the annular seal member 1300c in the loaded state is preferably greater than or equal to a preferred minimum diameter MinDIA of the internal surface of the adapter 1014 to maintain a preferred fluid flow through the annular seal member 1300c.

In some embodiments, the branch connector 1002 is a chambered branch connector (not shown) that includes a gasket chamber with a branch connector annular seal member similar to that shown in relation to FIGS. 2 and/or 6A. The chambered branch connector can include a single externally threaded annular seal member sized to fit in the gasket chamber, such as an appropriately sized annular seal member 1300c, annular seal member 400, and/or any other suitable annular seal member for forming a fluid-tight sealed engagement with the adapter 1014. The gasket chamber can be positioned between the internally threaded surface 1010 and the internal surface 1006 and can include a backstop.

FIG. 7D shows an alternate annular seal member 1300c. The annular seal member 1300c includes external threads 1308c that are continuous threads circumscribed around the entire outer diameter wall of the annular seal member 1300c. The annular seal member 1300c can include one or more insertion extrusions 1310 positioned around the inner wall 1306c. In one embodiment, the insertion extrusion 1310 is a rectangular extrusion that extends from the annular seat 1302c and the annular seat 1304c. In another embodiment, the insertion extrusion is any extruded shape extending from the inner wall 1306c positioned between the annular seat 1302c and the annular seat 1304c. In yet another embodiment, the insertion extrusion 1310 forms a cavity in the inner wall 1306c. In yet another embodiment, the insertion extrusion 1310 forms a cavity, and at least one insertion extrusion 1310 is positioned on the annular seat 1302c, and at least one insertion extrusion 1310c is positioned on the annular seat 1304.

With respect to FIGS. 5D, 6D, and 7D, the annular seal member 1300a, 1300b, 1300c (1300) has a threaded geometry that enables the annular seal member 1300 to be installed in either direction and into any of the branch connectors 702, 802 or adapter 1014. Additionally, the annular seal members 1300 can be installed directly onto the internally threaded surface 710, 810 of the branch connector 702, 802 or the internal thread 1016 of the adapter 1014, which eliminates the need for a complex and unique gasket chamber or the need for a gasket chamber. The annular seal member 1300 includes a peripheral or outer wall surface profile that defines an outer gasket diameter OGD of the annular seal member 1300 and an inner wall surface profile that defines an internal diameter IGD of the annular seal member 1300. One or both of the outer and inner gasket diameters OGD and IGD can be constant or alternately vary over the axial length or height of the annular seal member 1300. In preferred embodiments of the annular seal member 1300, the inner gasket diameter IGD is 80% of the maximum outer gasket diameter OGD. The outer gasket diameter OGD is defined by the major diameter of the external thread 1308a, 1308b, 1308c (1308).

The annular seal member 1300 preferably includes an annular seat 1302a, 1302b, 1302c (1302) for sealing against the surface of the backstop 708, 808, 1008 of the branch connector 702, 802 or adapter 1014 and an annular seat 1304a, 1304b, 1304c (1304) axially spaced from the annular seat 1302 for receipt of a fire protection device 200 when in a sealed engagement. Due to the reversible geometry of the annular seal member 1300, the annular seat 1304 can also be used to seal against the surface of the backstop 708, 808, 1008 of the branch connector 702, 802 or adapter 1014, and the annular seat 1302 can also be used for receipt of the fire protection device 200 when in a sealed engagement.

The annular seat 1302 and the annular seat 1304 are axially spaced apart from one another to define an overall height OH of the annular seal member 1300. The annular seat 1302 is preferably planar and disposed perpendicular to the longitudinal axis. The annular seat 1304 is preferably parallel to the annular seat 1302. Extending between the annular seats 1302, 1304 is an inner surface or wall 1306a, 1306b, 1306c (1306) and a preferred peripheral surface or wall containing external thread 1308. In one embodiment, the inner wall 1306 can be skewed with respect to an annular seat 1302 that can be, for example, planar to define a tapering flow through the region of the annular seal member 1300 that narrows in the direction from the annular seat 1302 toward the annular seat 1304. In another embodiment, the inner wall 1306 can be perpendicular with respect to an annular seat 1302 that can be, for example, planar. External threads 1308 are configured to align and thread into a corresponding internal thread. The annular seal member 1300 can provide for a fluid-tight seal under a fluid pressure of up to 200 psi or more, for example, pressures of up to and including at least 175 psi.

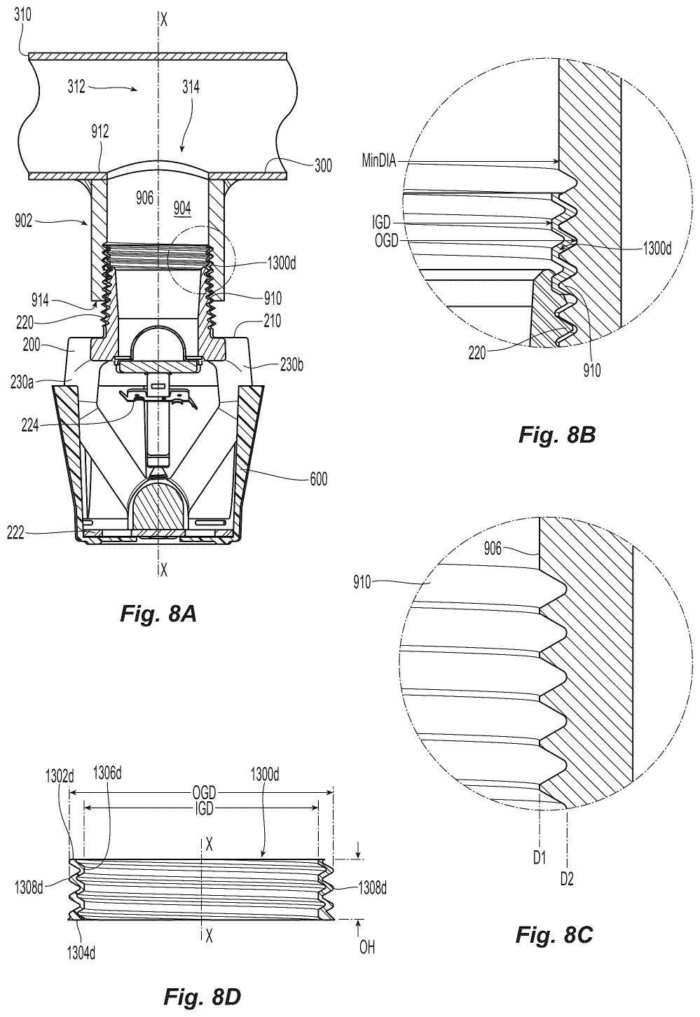

FIGS. 8A and 8B show an alternate annular seal member 1300d loaded by the fire protection device 200 in an alternate branch connector 902. FIG. 8C shows the branch connector 802 without the annular seal member 1300d. The branch connector 902 preferably connects to an appropriately configured fire protection device 200 using a protective device 600 that is located about the fire protection device 200. The branch connector 902 has an internal passageway 904 that includes the internally threaded surface 910, proximate to the outlet end 914 for receiving and coupling to the fire protection device 200. The internally threaded surface 910 extends from the outlet end 914 to the internal passageway 904. The internal passageway 904 is a stepless surface that extends from the internally threaded surface 910 to the inlet end 912. The internally threaded surface 910 houses and supports the annular seal member 1300d. The threads of the internally threaded surface 910 include a minor diameter D1. The minor diameter of a thread is the smallest diameter of the thread. In some embodiments, D1 is larger than the diameter of the internal surface 906. The thread includes a major diameter D2. The major diameter of a thread is the largest diameter of the thread. The difference between D1 and D2 is based on the thread size of the internally threaded surface 910.

The annular seal member 1300d forms a fluid-tight sealed engagement when engaged and loaded by the fire protection device 200. The fluid-tight sealed engagements between the internally threaded surface 910, the annular seal member 1300d, and the fire protection device 200 are formed upon sufficient rotation of the fire protection device 200 following contact with the annular seal member 1300d. In the loaded state, the annular seal member 1300d compresses and deforms by expanding radially outward against the threads of the internally threaded surface 910, increasing the outer gasket diameter OGD of the annular seal member 1300d. Moreover, by providing the radial outward expansion, the inner gasket diameter IGD of the annular seal member 1300d in the loaded state is preferably greater than or equal to a preferred minimum diameter MinDIA of the internal passageway 904 to maintain a preferred fluid flow through the annular seal member 1300d that is supplied to the fire protection device 200.

FIG. 8D is an alternate embodiment of the annular seal member. The annular seal member 1300d includes a peripheral or outer wall surface profile that defines an outer gasket diameter OGD and an inner wall surface profile that defines an internal gasket diameter IGD. One or both of the outer and inner gasket diameters OGD and IGD can be constant or alternately vary over the axial length or height of the annular seal member 1300d. In preferred embodiments of the annular seal member 1300d, the inner gasket diameter IGD is at least 90% of the maximum outer gasket diameter OGD. The outer gasket diameter OGD is defined by the major diameter of the external thread 1308d. The inner gasket diameter IGD is defined by the minor diameter of the internal thread 1306d. The annular seal member 1300d preferably includes a first seat 1302d and a second seat 1304d axially spaced from the first seat 1302d. The first seat 1302d and the second seat 1304d are axially spaced apart from one another to define an overall height OH of the annular seal member 1300d. The first seat 1302d is preferably planar and disposed perpendicular to the longitudinal axis. The second seat 1304d is preferably parallel to the first seat 1302d.

Extending between the first and second seats 1302d, 1304d is a preferred peripheral surface or wall containing external thread 1308d and an inner surface or wall containing internal thread 1306d. External threads 1308d are continuous threads circumscribed around the outer diameter wall of the annular seal member 1300d. External threads 1308d are configured to align and thread into a corresponding internal thread. In some embodiments, external threads 1308d are multiple sealing thread segments positioned around the outer diameter wall. The sealing thread segments can thread into an internal thread. When the annular seal member 1300d is installed into an internal thread, the external threads 1308d engage with the internal threads to support the annular seal member 1300d against the internal threads. The inner diameter wall of the annular seal member 1300d includes internal threads 1306d. Internal threads 1306d are continuous threads circumscribed around the inner diameter wall of the annular seal member 1300d. Internal threads 1306d are configured to align with the external threads 220 of the fire protection device 200 and enable the external threads 220 to thread into the internal threads 1306d. In some embodiments, internal threads 1306d are multiple sealing thread segments positioned around the inner diameter wall of the annular seal member. In some other embodiments, the annular seal member 1300d is positioned onto the external threads 220 of the fire protection device and then threaded into a branch connector.

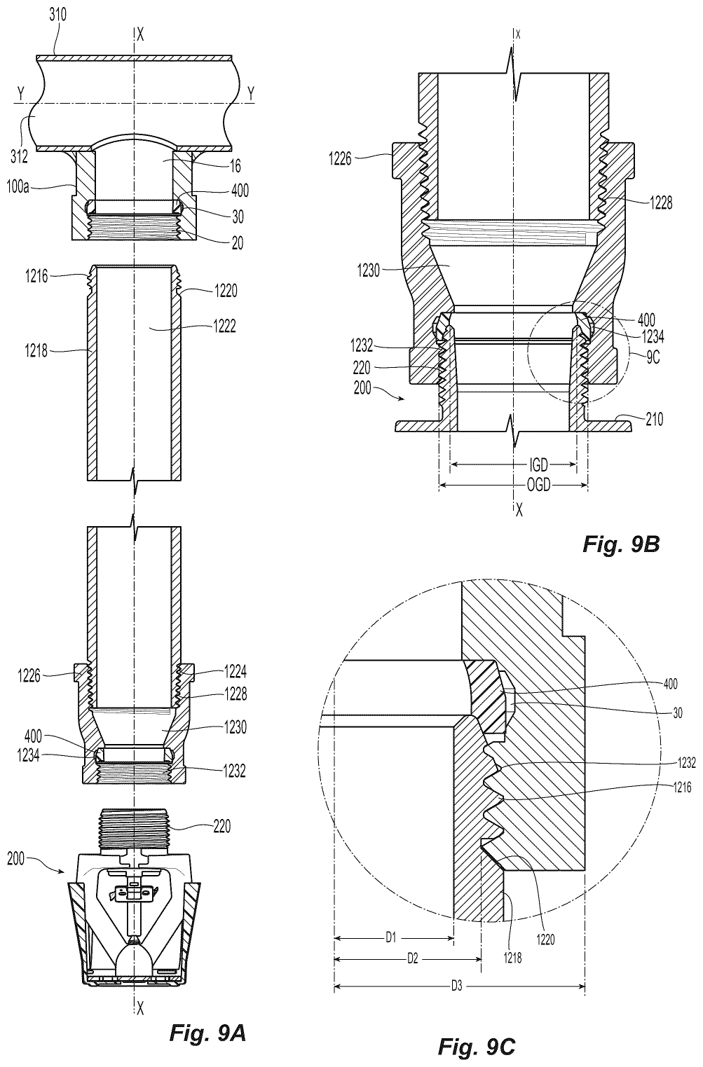

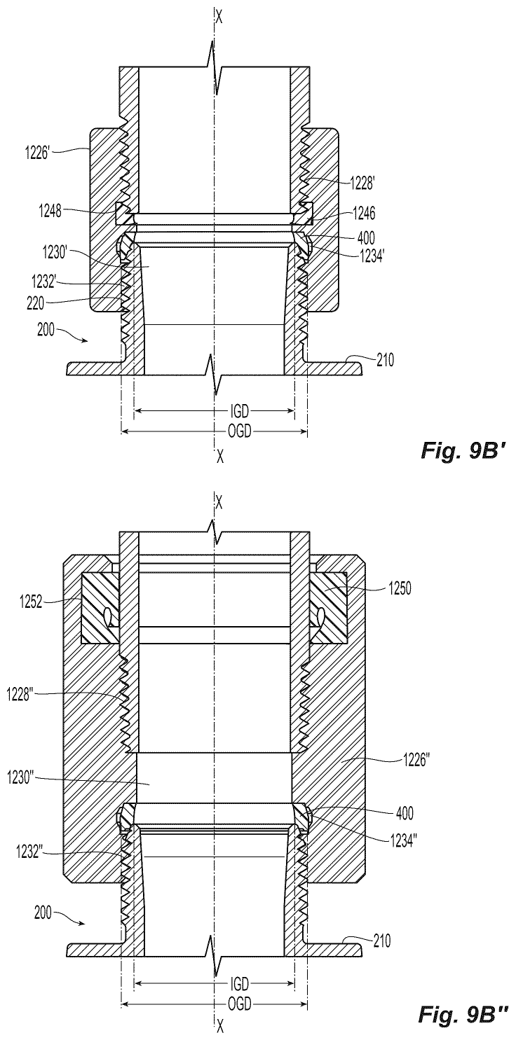

FIGS. 9A, 9B, and 9C show an embodiment of a pipe assembly that can be used as a sprig and/or drop assembly in a fire protection system using an annular seal member. The annular seal member is preferably the annular seal member 400 as shown and described in FIG. 4 and utilized in the sealing configurations of FIGS. 1A-3B. However, alternatively, the annular seal members and sealing configurations shown and described in FIGS. 5A-8D can be employed. The pipe assembly can include a branch connector 100a, a pipe 1218, and a fitting 1226. The pipe assembly can be configured to position fire protection device 200 above and/or below the branch connector 100a connected to pipe header 310. Branch connector 100a has the same internal geometry as branch connector 100, but with different external geometry. Branch connector 100a includes an internal passageway 16, gasket chamber 30, and internally threaded surface 20. Preferably, the branch connector 100a includes a corresponding surface at the entry within the second terminal end. The corresponding surface is disposed within the internal passageway 16 and extends from the entry toward the first terminal end. The entry is disposed at the second terminal end at the perimeter of the outlet of the internal passageway 16. The corresponding surface follows a helix about the central sprinkler axis X-X and can be a continuation of the internally threaded surface 20. The corresponding surface has a geometry different to the internally threaded surface 20. For example, the corresponding surface can have a length greater than the length between the major diameter and minor diameter of the internally threaded surface 16. In some other examples, the corresponding surface can be of a different thread size and/or type when compared to the internally threaded surface. Preferably, the corresponding surface has matching geometry to the thread stop 1220, so that the thread stop 1220 mates with the corresponding surface when the pipe 1218 is inserted into the branch connector 100a. The internally threaded surface 20 is coupled to an external inlet thread 1216 of the pipe 1218. External inlet threads 1216 are configured to thread into the internally threaded surface 20 to compress the annular seal member 400 housed in the gasket chamber 30 to form a fluid-tight seal. Pipe 1218 includes external inlet threads 1216, a pipe internal passageway 1222, and external outlet threads 1224. The external inlet threads 1216 can be a tapered thread and/or a straight thread.

Preferably, the pipe assembly includes a depth control mechanism to control the depth, the pipe 1218 is threaded into the branch connector, ensuring a proper fluid-tight seal between the pipe 1218 and the branch connector 100a. The branch connector 100a and/or the pipe 1218 can include the depth-control mechanism for controlling how far the pipe 1218 can be inserted into the branch connector 100a. For example, the depth-control mechanism can inhibit the pipe 1218 from being threaded farther into the connector 100a when the depth-control mechanism engages with the connector 100a. In preferred embodiments, the depth-control mechanism is the thread stop 1220, which can be a physical barrier (e.g., surface) positioned on the outer wall of the pipe 1218 between the external inlet threads 1216 and external outlet threads 1224. Preferably, the position of the thread stop 1220 on the external wall of the pipe 1218 is a predetermined position that corresponds to a point where the annular seal member 400 is sufficiently compressed to form a fluid-tight seal. The thread stop 1220 is a surface that contacts a corresponding surface within the entry of the internal passage 16 at the second terminal end of the branch connector 100a. During insertion of the pipe 1218 into the branch connector 100a, the thread stop 1220 preferably, provides a physical stop to prevent further insertion. Preferably, the entry is disposed within the internal passageway of the branch connector 100a. Additionally, the corresponding surface within the entry can follow a helix about the central sprinkler axis X-X. More preferably, the thread stop 1220 and the corresponding surface at the entry are both disposed within the internal passageway when the thread stop 1220 is in contact with the corresponding surface.

The thread stop 1220 can be disposed along the central sprinkler axis X-X, preferably on a helix about the central sprinkler axis X-X. In some embodiments, the thread stop 1220 is a chamfered edge and/or angled surface on the outer diameter wall of the inlet fitting 1116 and is contiguous to the external inlet threads 1216. The thread stop 1220 surface, may have a constant geometry about the central sprinkler axis. Alternatively, the thread stop 1220 can have a varying and/or non-continuous geometry. For example, the size of the thread stop 1220 can vary as the thread stop 1220 transitions from a geometry of the external inlet threads to a different surface having a different geometry when compared to the external inlet threads. When the thread stop 1220 is non-continuous, there are multiple thread segments along the helix. In some other embodiments, the thread stop is a linear surface perpendicular to the central sprinkler axis X--X and the outer diameter wall of the inlet fitting 1116. The thread stop 1220 may be disposed within a plane perpendicular to the central sprinkler axis X--X.

Preferably, a maximum diameter of the thread stop 1220 is between the outer diameter of the pipe 1218 and the major diameter of the external inlet threads 1216. However, in some embodiments, the thread stop 1220 can have a maximum diameter that is greater than the outer diameter of the pipe 1218. In regard to FIGS. 9A-9C, preferably, the thread stop 1220 can extend from the outer diameter of the pipe 1218 to the minor diameter D2 of the external inlet threads 1216. For example, when the external inlet thread 1216 is a tapered thread (e.g., NPT thread), the maximum diameter of the thread stop 1220 is larger than the last thread (e.g., largest) thread of the external inlet thread 1216. The thread stop 1220 may be a continuation of the last thread of the external inlet threads 1216. In some embodiments, the thread stop 1220 is a thread of a different thread size and/or thread type than the threads of the external inlet threads 1216. For example, the thread stop 1220 can include a first surface and a second surface angled toward each other to form a thread geometry different to that of the external inlet threads 1216. In some embodiments, the thread stop 1220 includes a first surface contiguous to the last thread (e.g., the thread furthest from the terminal end of the pipe 1218 that is threaded into the branch connector 100a). The first surface extends on the helix along the central sprinkler axis X-X. A second surface extends from the first surface at the end opposite the external inlet thread 1216. The second surface extends from the first surface to the outer surface of the pipe 1218, therefore the length of the second surface is greater than the distance of the minor diameter to the major diameter of each thread in the external inlet threads 1216.

In some embodiments, a user inserts the pipe 1218 into the branch connector 100a by threading the external inlet threads 1216 into the internally threaded surface 20 of the branch connector 100a. The user threads the pipe 1218 into the branch connector 100a until the thread stop 1220 contacts a corresponding surface at the terminal end of the branch connector 100a. When contact between the thread stop 1220 and the corresponding surface of the branch connector 100a is made, the pipe 1218 is maximumly threaded into the branch connector 100a and a fluid-tight seal is generated between the pipe 1218 and the branch connector 100a due to the proper compression of the annular seal member 400. Therefore, the thread stop 1220 controls the depth at which the pipe 1218 is inserted into the branch connector 100a based on the position (e.g., a predetermined position) of the thread stop 1220 on the pipe 1218. By controlling the depth of the pipe 1218 is inserted, the thread stop 1220 provides appropriate compression of the annular seal member 400 to generate a fluid-tight seal between the pipe 1218 and the branch connector 100a. Therefore, the thread stop 1220 provides a self-sealing system that ensures a seal between the pipe 1218 and the branch connector 100a meaning that a user is not required to confirm that a proper seal is made. Additionally, the contact of the surface of the thread stop 1220 with the corresponding surface positioned at the second terminal end of the branch connector 100a limits the lateral movement of the connection between the pipe 1218 and the branch connector 100a. Preferably, the surface of the thread stop 1220 is disposed on the helix about the central sprinkler axis X-X and the corresponding surface of the branch connector is disposed on a corresponding helix about the central sprinkler axis X-X. The thread stop can limit and/or prevent lateral movement of the pipe 1218 relative to the branch connector 100a, for example to no more than 10 degrees of movement of the central axis of the pipe 1218 relative to the central axis of the branch connector 100a, and preferably by no more than 5 degrees and even more preferably by 0 degrees. Limiting the lateral movement of the connection therefore provides a stable connection between the pipe 1218 and the branch connector 100a so that a proper connection between the pipe 1218 and the branch connector 100a is maintained even when the fire protection system is exposed to environmental conditions and/or water supply conditions that cause vibration of the fire protection system.

Fitting 1226 is coupled to the outlet end of the pipe 1218. Fitting 1226 includes the internal inlet threads 1228, the internal passageway 1230, the fitting gasket chamber 1234, and internal outlet threads 1232. The internal inlet threads 1228 couple to the external outlet threads 1224 to form a fluid-tight seal. The internal inlet threads 1228 can be any connection method capable of forming the fluid-tight seal, for example a tapered thread, straight threads with a gasketed connection, a coupling configured for either a grooved or plain pipe end, and/or welded. In some embodiments, the diameter of the internal passageway 1230 decreases as the internal passageway 1230 extends from the inlet end to the outlet end. For example, the diameter of internal passageway 1230 can taper from a diameter of one inch to three-fourths inches. In some other embodiments, the internal passageway 1230 has a constant internal diameter. Fitting gasket chamber 1234 is configured to house a second annular seal member 400 and form a fluid-tight seal between fitting 1226 and fire protection device 200. The fluid-tight seal is formed when external threads 220 of the fire protection device 200 are threaded into internal outlet threads 1232. Threading the fire protection device 200 into fitting 1226 compresses the annular seal member 400 into the fitting gasket chamber 1234. The fitting 1226 can have a variable outer diameter or a constant outer diameter. In some embodiments, the pipe 1218 and the fitting 1226 are a single unitary member.

FIG. 9B′ shows an alternate embodiment of the pipe assembly of FIG. 9B. The alternate embodiment includes fitting 1226′ coupled to the outlet end of the pipe 1218 in a gasketed connection and coupled to the fire protection device 200 in a gasketed connection. The fitting 1226′ can be a unitary member with an outer surface, preferably a cylindrical outer surface with a constant diameter. However, any shaped outer surface can be used, for example a tapered outer surface, a fusiform outer surface, or an outer surface with a varying diameter. The outer diameter of the fitting 1226′can be an identical to or less than the diameter of the pipe 1218, but is preferably greater than the diameter of the pipe 1218. The fitting 1226 is preferably threaded to the pipe 1218. Alternatively, the pipe 1218 can be provided with a thread stop and/or without an external thread. The pipe 1218 can alternatively be connected to the fitting 1226 by a welded connection, a coupling, and/or any suitable connection means.

Preferably, the fitting 1226′ includes the internal inlet threads 1228′, a first fitting gasket chamber 1248, an internal passageway 1230′, a second fitting gasket chamber 1234′, and internal outlet threads 1232′. The internal inlet threads 1228′ couple to the external outlet threads 1224. The first fitting gasket chamber 1248 is positioned between the internal inlet threads 1228′ and the internal passageway 1230′. The first fitting gasket chamber 1248 is configured to house an annular seal member 1246. The first fitting gasket chamber 1248 can have the same geometry as the gasket chamber 30 or have a square or rectangular geometry. The annular seal member 1246 can have a square geometry and/or any annular seal member geometry disclosed herein. The external outlet threads 1224 compress the annular seal member 1246 into the first fitting gasket chamber 1248 to create a fluid-tight seal between the pipe 1218 and the fitting 1226′. The second gasket chamber 1234′ is configured to house a second annular seal member 400, and/or any other annular seal member disclosed herein, and form a fluid-tight seal between fitting 1226′ and fire protection device 200. The fluid-tight seal is formed when external threads 220 of the fire protection device 200 are threaded into internal outlet threads 1232′. Threading the fire protection device 200 into fitting 1226′ compresses the annular seal member 400 into the fitting gasket chamber 1234′.

FIG. 9B″ shows an alternate embodiment of the pipe assembly of FIG. 9B. The alternate embodiment includes fitting 1226″ coupled to the outlet end of the pipe 1218 in any manner described herein in relation to FIG. 9B′. Fitting 1226″ includes the internal inlet threads 1228″, a first fitting gasket chamber 1252, an internal passageway 1230″, a second fitting gasket chamber 1234″, and internal outlet threads 1232″. The internal inlet threads 1228″ couple to the external outlet threads 1224. The first fitting gasket chamber 1252 is positioned between the internal inlet threads 1228″ and the internal passageway 1230″. The first fitting gasket chamber 1252 is configured to house an annular seal member 1250. The first fitting gasket chamber 1252 can have the same geometry as the gasket chamber 30 or have a square or rectangular geometry. The annular seal member 1250 can include a flexible protrusion that is configured to compress against itself when the external outlet threads 1224 are threaded into the fitting 1226″. The annular seal member 1250 can include a chamber or spacing between a main body of the annular seal member 1250 and the flexible protrusion. Alternatively, the annular seal member 1250 can have a square geometry or a matching geometry to the annular seal member 400. The outer diameter of the pipe 1218 compresses the annular seal member 1250 into the first fitting gasket chamber 1252 and against itself to create a fluid-tight seal between the outer surface of the pipe 1218 and the fitting 1226″. The second gasket chamber 1234″ is configured to house a second annular seal member 400, and/or any other annular seal member disclosed herein and form a fluid-tight seal between fitting 1226″ and fire protection device 200. The fluid-tight seal is formed when external threads 220 of the fire protection device 200 are threaded into internal outlet threads 1232″. Threading the fire protection device 200 into fitting 1226″ compresses the annular seal member 400 into the fitting gasket chamber 1234″. The fitting 1226″ can have a constant outer diameter and/or any profile described in relation to FIG. 9B′.

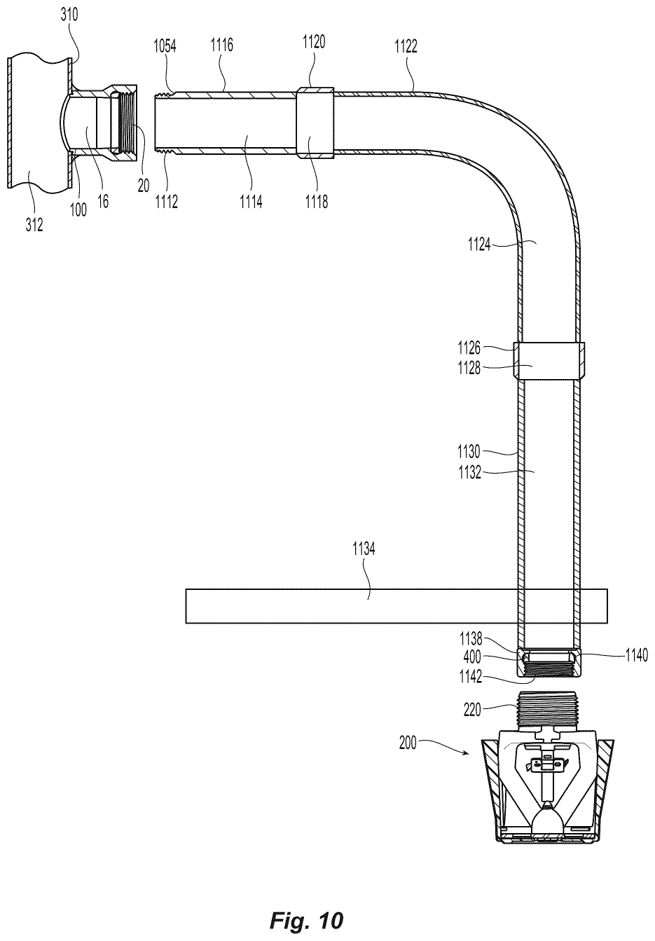

FIG. 10 shows an embodiment of a flexible tubular member assembly in a fire protection system using an annular seal member. The flexible tubular member assembly is configured to position fire protection device 200 below branch connector 100 connected to pipe header 310. Alternatively, the flexible tubular member assembly positions the fire protection device 200 above the branch connector 100. The branch connector 100 can extend horizontally and/or vertically from pipe header 310. The branch connector 100 includes an internal passageway 16, an internally threaded surface 20, and a gasket chamber 30 which houses an annular seal member 400 and/or any other annular seal member geometry disclosed herein. The internally threaded surface is coupled to an inlet fitting 1116 of the flexible tubular member assembly. Inlet fitting 1116 includes inlet fitting external threads 1112, inlet fitting internal passageway 1114, inlet hose connector 1120, and inlet hose connector passageway 1118. Inlet fitting external threads 1112 are configured to thread into internally threaded surface 20 to form a fluid-tight seal by compressing the annular seal member 400 housed in the gasket chamber 30. In preferred embodiments, the inlet fitting 1116 includes a thread stop 1154 positioned on the external wall of the inlet fitting 1116 between the external threads 1112 and the inlet hose connector 1120. The thread stop 1154 can be configured as an identical thread stop to thread stop 1220 as described in relation to FIGS. 9A, 9B, and 9C.

Hose 1122 is a flexible tubular member that bends without obstructing the flow of firefighting fluid through hose internal passageway 1124. Hose 1122 is coupled to the outlet fitting 1130. Outlet fitting 1130 includes outlet fitting internal passageway 1132, outlet hose connector 1126, and outlet hose connector passageway 1128. In some embodiments, outlet fitting 1130 is supported by support bracket 1134. The gasketed fitting 1138 is coupled (e.g., welded, threaded, press fit, etc.) to an outlet end of outlet fitting 1130. The gasketed fitting 1138 can be coupled to the flexible hose in any manner including every method described in relation to FIGS. 9A, 9B, 9B′, 9B″, and/or 9C. The gasketed fitting 1138 can be a straight fitting, a reducing fitting, or an expansion fitting. the gasketed fitting can have a constant or variable outer diameter. The gasket fitting 1138 can be a single gasketed and/or a double gasketed fitting. The gasketed fitting 1138 can be a different fitting or the same fitting described above in relation to FIGS. 9B, 9B′, and 9B″. The gasketed fitting 1138 includes an internal thread 1142, a gasket chamber 1140, and an annular seal member 400 and/or any other annular seal member disclosed herein. Gasket chamber 1140 is configured to house annular seal member 400 and form a fluid-tight seal between gasketed fitting 1138 and fire protection device 200 when the external threads 220 of the fire protection device 200 are threaded into internal threads 1142. The gasket chamber 1140 can have the same geometry and dimensions as gasket chamber 30. Threading fire protection device 200 into gasketed fitting 1138 compresses the annular seal member 400 into the gasket chamber 1140. In some embodiments, the flexible hose assembly can include the fitting 1226 instead of the gasketed fitting 1138.

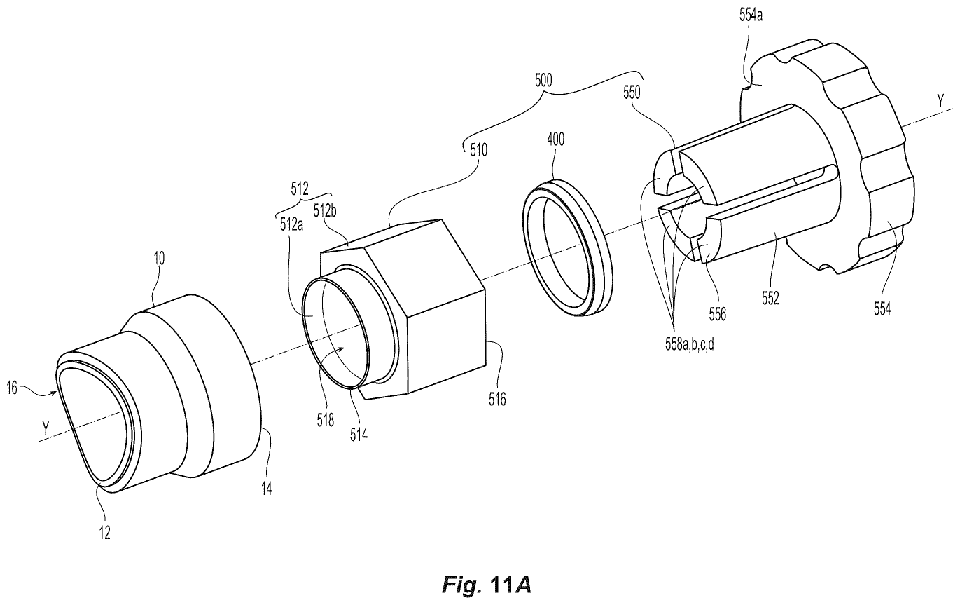

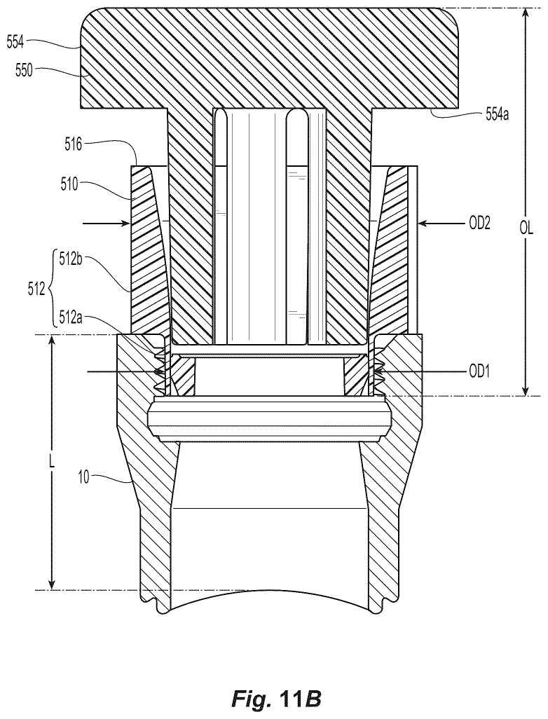

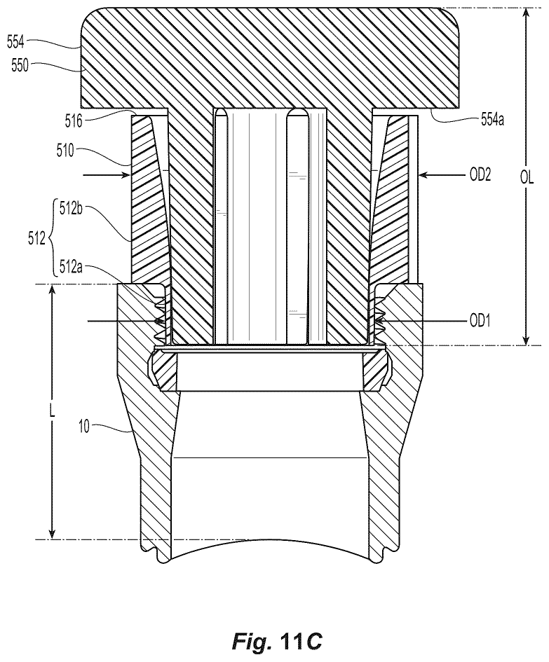

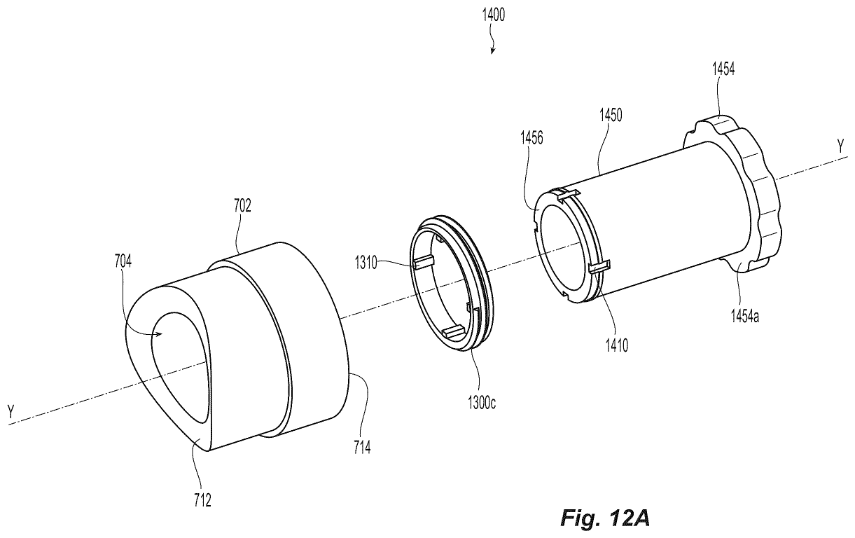

Shown in FIGS. 11A, 11B and 11C is a preferred installation tool 500 for installing and locating the preferred annular seal member 400 within the gasket chamber 30. The preferred installation tool 500 includes a nozzle member 510 and a plunger member 550. The nozzle member 510 is generally a tubular body 512 having a first end face 514 and a second end face 516 axially spaced from the first end face 514 with a guidance channel 518 that extends axially from the first end face 514 to the second end face 516 along a central longitudinal axis Y--Y. The plunger member 550 is generally an axially extending member having a rod portion 552 with a handle portion 554 preferably formed or affixed at one end of the rod portion 552 with a free end 556 formed or provided opposite the handle portion 554.

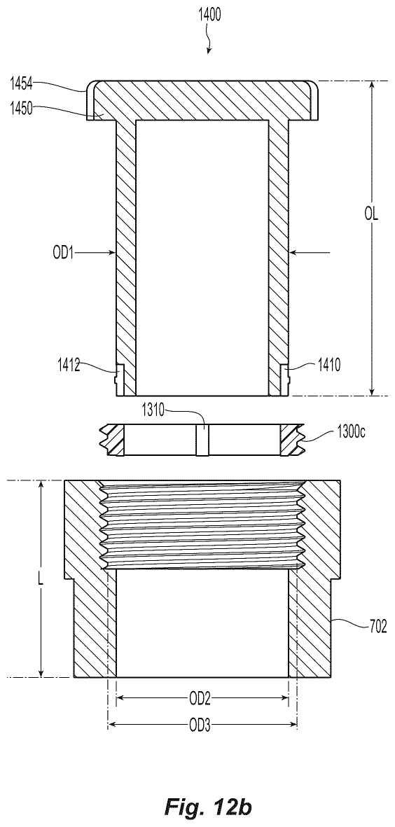

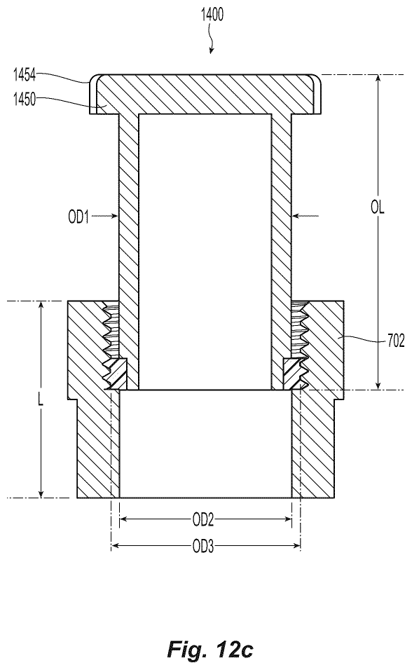

In the preferred interconnection assembly, the branch connector 100 and its inlet end 12 can be coupled or affixed to a pipe header 310 or otherwise free for connection at a later time. The annular seal member 400 is disposed or held within and coaxially aligned within the guidance channel 518 of the nozzle member 510. The first end face 514 of the nozzle member is inserted into the outlet end 14 of the branch connector 100 which coaxially aligns the guidance channel 518 of the nozzle member 510 with the internal passageway 16 of the branch connector 100. The plunger member 550 is also coaxially aligned with the internal passageways of the nozzle member 510 and branch connector 100 by locating the rod portion 552 of the plunger member 550 within the nozzle member 510 proximate the seal member 400 in a preferred sliding engagement. In operation, the plunger member 550 is axially depressed to axially slide or drive the rod portion 552 within the guidance channel 518 to drive and eject the annular seal member 400 out of the nozzle member 510 and into the preferred branch connector 100. More preferably, the relative translation between the nozzle and plunger members 510, 550 defines a first position of the handle portion 554, as seen in FIG. 12B, axially spaced from the second end face 516 of the nozzle member 510 with the free end 556 of the rod portion 552 proximate the annular seal member 400 within the guidance channel 518. The first position defines a first operational length OL between the handle portion 554 and the first end face 514. The sliding engagement also defines a second position of the handle portion 554 proximate, and more preferably abutting, the second end face 516 of the nozzle member 510, as seen for example in FIG. 12C, such that the free end 556 ejects the annular seal member 400 out of the guidance channel 518 and into the desired location within the internal gasket chamber 30 of the branch connector 100. In each of the first and second positions, the handle portion remains centered and coaxially aligned with the central axis Y--Y. In a preferred aspect of the second position, the free end 556 of the rod portion 552 is flush with the first end face 514 of the nozzle member. Alternatively or additionally, the rod portion 552 of the plunger member 550 can form an interference fit within the guidance channel 518 of the nozzle member 510 to limit the axial travel of the plunger 550 within the nozzle member 510 and define the second position of the handle portion 554.

The installation tool 500 is preferably configured for use to replace an annular seal member 400 of a branch connector 100 connected to an installed pipe header 310. Accordingly, the installation tool 500 is preferably dimensioned to be sized and operate within a space that may include obstructions around the pipe header. Each of the nozzle member 510 and plunger member 550 defines an axial length that is three-fourths to one and one-fourth times (0.75-1.25×) the axial length L of the branch connector 100. Moreover, the operational length OL of the installation tool 500 preferably ranges from a maximum length of three to two and one-half times (3×-2.5 ×) the axial length L of the branch connector 100 when the handle portion 554 is in the first position to a minimum of one and one-half to one times (1.5×-1×) the length L of the branch connector 100 when the handle portion 554 is in the second position. The preferred operational length OL of the tool assembly allows operation of the tool assembly in close proximity of obstructions to the pipe header 310 such as, for example, ceilings or ducts. The handle portion 554 is preferably configured for peripheral gripping with a continuous preferably uniform peripheral contour circumscribed about the device axis. The handle portion 554 has a preferred width diameter that is greater than the collective diameter or width of the rod portion 552 and its projection members. Accordingly, the handle portion 554 includes a transverse base surface 554a to which the projection members are preferably affixed. The exposed radially extending base surface contacts the nozzle member 510 in the second operational position of the handle portion 554. Moreover, the handle portion 554 has a preferred diameter that is preferably less than the operational length of the tool assembly and preferably 50% to 100% of the axial length of the tool length when the handle portion 554 is in the second position. Moreover, the handle portion 554 has a preferred axial thickness or height that is less than the rod portion 552 of the plunger 550 and more preferably has an axial length that is 25% to 33% the axial length of the rod portion 552 and even more preferably 15% to 25% the axial length of the rod portion 552.

Preferred features of the branch connector 100 and the installation tool 500 are shown. The rod portion 552 preferably includes a plurality of spaced apart projection members 558 that extend axially from the handle portion 554. More preferably, each of the axially extending projection members 558 are elongated and arcuate having a common central axis of curvature shown coaxially aligned with the central axis Y--Y. In the preferred embodiment, the rod portion 552 is defined by four arcuate members 558a, 558b, 558c, 558d that are arranged to partially circumscribe the central axis Y--Y. The free end of each member 558 provides a planar surface to contact the seal member 400 and displace it out of the nozzle member 510.

The guidance channel 518 of the nozzle member 510 defines a preferred guidance channel for holding the annular seal member and through which the plunger member slides to displace the annular member 400 in a preferred orientation for insertion into the gasket chamber 30 of the branch connector 100. In the preferred embodiment, the guidance channel 518 is preferably tapered in the direction from the receiver or second end face 516 of the nozzle member toward the insertion or first end face 514. More preferably, the guidance channel 518 includes a first tapering portion having an internal diameter that is preferably wide enough at the second end face 516 (e.g., receiving end) to sequentially insert the annular seal member 400 and the plunger 550. A second portion of the guidance channel 518 is defined by the narrowest portion of the channel to permit the annular seal member 400 to be coaxially oriented and centered about the central axis of the nozzle member 510 while being wide enough to permit the seal member 400 to be ejected under the displacement of the plunger member 550. The narrowest portion of the guidance channel 518 can support the annular seal member 400 in the preferred orientation. Moreover, the narrowest portion of the guidance channel 518 preferably radially compresses the spaced apart projection members 558 towards one another to collectively present the free end 556 of the plunger member 550 to the sealing surface of the seal member 400. The narrowest portion of the guidance channel 518 preferably extends axially to the first end face 514 at a constant internal diameter to maintain the seal in the preferred coaxially aligned orientation for ejection from the first end face 514 and into the gasket chamber 30 of the branch connector 100. In a preferred aspect of the installation tool 500, the seal does not fold upon itself so that it may be ejected and inserted in the desired orientation.

The preferred nozzle member 510 has an outer geometry that facilitates its use with the branch connector 100 and the plunger member 550. The tubular body 512 of the nozzle member 510 preferably includes a first portion 512a defining a first outer diameter preferably sufficient to be axially inserted into the branch connector 100 and a second portion 512b defining a second larger outer diameter that limits the insertion of the nozzle member 510 into the branch connector 100. The first outer diameter OD1 of the first portion 512a is preferably sized so that the first portion 512a can be inserted by sliding the first portion 512a into the threaded outlet portion at the outlet 14 of the branch connector 100. More preferably, the first outer diameter OD1 is sized to form a sliding contact engagement with the internal thread of the outlet portion 20 of the branch connector 100 which facilitates the coaxial alignment of the guidance channel 518 of the nozzle member 510 with the internal passageway 16 of the branch connector 100. To axially limit the insertion of the nozzle member 510, the second outer diameter OD2 is preferably larger than the outlet opening 14 of the branch connector 100. As seen in FIG. 12B, the second portion 512b preferably defines a stop surface about the body 512 that abuts the outlet end face of the branch connector upon the insertion of the first portion 512a into the threaded portion of the branch connector 100.

The insertion portion 512a of the nozzle member 510 defines an axial length that is preferably equal to the axial length of the internal thread of the branch connector 100. In the preferred embodiment, the complete insertion of the first portion of the nozzle member 510 into the branch connector 100 preferably locates the first end face 514 of the nozzle member outside and proximate to, and even more preferably immediately next to, the internal gasket chamber of the branch connector 100. The preferred inserted location of the end face of the nozzle facilitates the insertion of the annular member 400 into the gasket chamber 30 upon the ejection from the nozzle guidance channel 518.

FIGS. 12A, 12B, and 12C illustrate an insertion tool 1400 for installing the annular seal member 1300c into the branch connector 702 or any alternative branch connector 802 or adapter 1014. The insertion tool 1400 is generally an axially extending member having a rod portion 1450 and a handle portion 1454, preferably formed or affixed at one end of the rod portion 1450 with a free end 1456 formed or provided opposite the handle portion 1454. The insertion tool 1400 includes at least one insertion extrusion 1410 extending from the free end 1456 along the rod portion 1450. In one embodiment, insertion extrusion 1410 are cavities that extend towards the center of the rod portion 1450 and are circumscribed around the rod portion 1450 at regular intervals, such as every 90 or 120 degrees. In another embodiment, the insertion extrusion 1410 extends outwardly from the rod portion 1450. In yet another embodiment, the insertion extrusion 1410 extends outwardly from the free end 1456.

The insertion extrusion 1410 of the insertion tool 1400 couples to and corresponds to the insertion extrusion 1310 of the annular seal member 1300c. Coupling the insertion extrusion 1410 to the insertion extrusion 1310 enables the insertion tool 1400 to engage the threads of the annular seal member 1300c with the internally threaded surface 710 of the branch connector 702 so that a torque can be applied to the annular seal member 1300c so as to translate the annular seal member 1300c axially along the internally threaded surface 710 until the annular seal member 1300c is positioned against the surface of the backstop 708. Torque is applied and the annular seal member 1300c is translated by rotating the insertion tool 1400 about its center axis.

The insertion tool 1400 is configured to insert or replace an annular seal member 1300c of a branch connector 702 connected to an installed pipe header 310. Accordingly, the insertion tool 1400 is dimensioned to be sized and operated within a space that may include obstructions around the pipe header. The installation tool 500 defines an axial length of three-fourths to one and one-fourth times (0.75-1.25×) the axial length L of the branch connector 702. Moreover, the operational length OL of the insertion tool 1400 preferably ranges from a maximum length of three to two and one-half times (3×-2½×) the length of the internally threaded surface 710 of the branch connector 702 when the handle portion 1454 is in an initial position to a minimum of one and one-half to one times (1.5×-1×) the length of the internally threaded surface 710 of the branch connector 702 when the handle portion 1454 is in the final position. The initial position corresponds to when the insertion tool 1400 initially engages the external threads 1308c of the annular seal member 1300c with the internally threaded surface 710. An inserted position corresponds to when the insertion tool 1400 has positioned the annular seal member 1300c against the backstop 708. The preferred operational length OL of the insertion tool 1400 allows for operation of the installation tool 500 in close proximity to any obstructions near the pipe header 310, such as, for example, ceilings or ducts.

The handle portion 1454 has a diameter that is greater than an outer diameter OD1 of the rod portion 1450. The handle portion 1454 includes a transverse base surface 1454a to limit the distance the insertion tool 1400 can be inserted into the branch connector 702. The outer diameter OD1 of the rod portion 1450 is preferably greater than the outer diameter OD2 of the internal surface 706 to prevent the insertion tool from being inserted past the backstop 708. Moreover, outer diameter OD1 of the rod portion 1450 is less than the outer diameter OD3 to prevent the rod portion 1450 from damaging the internally threaded surface 710 during insertion of the annular seal member 1300c.

It should be understood that any numerical range, value, dimension or percentage value or approximation thereof provided herein can vary by ±10% unless otherwise already understood and established by accepted industry or manufacturing standards.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1-32. (canceled)

33. A fire protection system, comprising:
a pipe header having an internal fluid passageway extending along a longitudinal axis, the pipe header having an opening formed on a wall of the pipe header;
a branch connector having a first terminal end, a second terminal end, an internally threaded surface extending from the second terminal end towards the first terminal end, and a branch connector gasket chamber including a first annular seal member housed and supported therein;
a pipe assembly including:
a pipe having an inlet end, an outlet end, an external inlet thread extending from the inlet end towards the outlet end, an external outlet thread, a thread stop positioned between the external inlet thread and the external outlet thread and including a stop surface that contacts a corresponding surface at the terminal end of the branch connector to control a depth the pipe is inserted into the branch connector, the stop surface being disposed between a minor diameter of the external inlet thread and an outer diameter of the pipe, having a geometry different than the external inlet thread, and having a maximum diameter less than a maximum diameter of the pipe and greater than a maximum thread diameter of the external inlet thread, and an internal surface;
a fitting including an internal inlet thread coupled to the external outlet thread of the pipe, a fitting gasket chamber, an internal outlet thread extending from an outlet fitting end to the fitting gasket chamber, and a tapered internal surface positioned between the internal inlet thread and the fitting gasket chamber; and
a second annular seal member positioned in the fitting gasket chamber, and
a fire protection device comprising:
a fire protection device having a frame body with a frame inlet, a frame outlet, and a frame internal passageway extending from the frame inlet to the frame outlet along a device axis, the frame body coupled to the fitting to compress the second annular seal member and establish the frame internal passageway of the fire protection device in fluid communication with the fluid passageway of the pipe header; and
a fluid deflection member coupled to the frame.

34. The fire protection system of claim 33, wherein the fitting gasket chamber includes a backstop surface for sealing engagement with the second annular seal member, the backstop surface being a planar surface circumscribed about and perpendicular to a central axis of the fitting.

35. The fire protection system of claim 34, wherein the fitting gasket chamber surface includes a first restriction defining a first internal diameter of the fitting; a second restriction axially spaced from the first restriction, the second restriction defining a second internal diameter of the fitting, the first and second restriction engaging a peripheral surface of the second annular seal member to support the second annular member; and a relief wall between the first restriction and the second restriction, the relief wall defining a third internal diameter of the fitting greater than the first and second internal diameters.

36. The fire protection system of claim 35, wherein the first restriction includes a first portion disposed perpendicular to the central axis and a second portion adjacent and contiguous with the backstop surface, the second portion of the first restriction being skewed with respect to the central axis.

37. The fire protection system of claim 36, wherein the branch connector gasket chamber has an identical geometry as the fitting gasket chamber of the fitting.

38. The fire protection system of claim 33, wherein the stop surface is an external thread of a larger thread size compared to the external inlet thread of the pipe.

39. The fire protection system of claim 33, wherein the surface of the thread stop is circumscribed about an outer diameter wall of the inlet fitting and extends perpendicular to a central pipe axis.

40. The fire protection system of claim 39, wherein the surface of the thread stop is circumscribed about an outer diameter wall of the pipe and extends at an angle relative to a central pipe axis.

41. The fire protection system of claim 33, wherein the pipe is a tubular member and wherein the internal surface of the pipe is a stepless surface extending from the inlet end to the outlet end.

42-82. (canceled)
